(19) United States
(12) Patent Application Publication
(10) Pub. No.: US 2025/0226478 A1
(43) Pub. Date: Jul. 10, 2025

(54) Battery Heater Failsafe Circuit

(71) Applicant: Google LLC, Mountain View, CA (US)

(72) Inventors: Sree Anantharaman Raman, Los Altos, CA (US); Arun Jayadev Rao, Sunnyvale, CA (US); Ford Rylander, San Francisco, CA (US); Anna Hwang, Los Altos, CA (US)

(73) Assignee: Google LLC, Mountain View, CA (US)

(21) Appl. No.: 18/853,383

(22) PCT Filed: Aug. 2, 2022
(86) PCT No.: PCT/US2022/074436

§ 371 Date: Oct. 1, 2024

(51) Int. Cl. H01M 10/633; H01M 10/48; H01M 10/615; H01M 10/627; H01M 10/6571; H04N 7/18

(52) U.S. Cl. CPC H01M 10/633; H01M 10/486; H01M 10/615; H01M 10/627; H01M 10/6571; H04N 7/183

(57) ABSTRACT

The present document describes systems and techniques of a battery heater failsafe circuit in a video-capturing doorbell. In aspects, the battery heater failsafe circuit is configured to monitor a temperature of one or more regions proximate or adjacent to a battery. If, while under software control of a processing unit, a battery heater is activated and, due to a software malfunction, the battery approaches or is equal to an upper threshold temperature, then the battery heater failsafe circuit can override the software-control of the battery heater to disconnect the battery heater from the processing unit and/or the battery. When, as a result, the temperature of the battery equals or drops below a lower threshold temperature, the battery heater failsafe circuit is capable of reconnecting the battery heater to the processing unit and/or the battery sufficient to enable a reactivation of the battery heater and allow heat generation.

### BACKGROUND

With advances in home security systems, including video-capturing doorbells, a user can be notified of events occurring in proximity to their house. For example, a user can view a visitor outside their home by using an electronic device to access images of a video feed captured by a camera of the doorbell. These home security systems provide users superior and reliable security, easing any worries that a user may have while away from home, for example. However, these home security systems are often subject to extreme climates, such as high or low temperatures, which may influence the reliability of these systems.

### SUMMARY

The present document describes systems and techniques of a battery heater failsafe circuit in a video-capturing doorbell. In aspects, the battery heater failsafe circuit is configured to monitor a temperature of one or more regions proximate, adjacent, or internal to a battery. If, while under software control of a processing unit, a battery heater is activated and, due to a software malfunction, the battery approaches or is equal to an upper threshold temperature, then the battery heater failsafe circuit can override the software-control of the battery heater to disconnect the battery heater from the processing unit and/or the battery. When, as a result, the temperature of the battery equals or drops below a lower threshold temperature, the battery heater failsafe circuit is capable of reconnecting the battery heater to the processing unit and/or the battery sufficient to enable a reactivation of the battery heater and allow heat generation.

In aspects, a video-capturing doorbell is disclosed that includes a battery configured to supply electrical energy to one or more electrical components within the video-capturing doorbell. The video-capturing doorbell further includes a heat sensor configured to measure a temperature of one or more regions proximate, adjacent, or internal to the battery. The video-capturing doorbell also includes a battery heater configured to generate heat to warm the battery and/or an internal temperature of the video-capturing doorbell. The video-capturing doorbell further includes a processing unit configured to activate and deactivate the battery heater, as well as a battery heater failsafe circuit configured to: (i) determine, based on a comparison, that the temperature exceeds an upper threshold temperature due to the heat generation by the battery heater; and (ii) disconnect, responsive to the determination that the temperature exceeds the upper threshold temperature, the battery heater from the processing unit sufficient to deactivate the battery heater and suspend the heat generation.

In aspects, a method of a video-capturing doorbell, the method is disclosed that includes: measuring a temperature of one or more regions proximate, adjacent, or internal to a battery; determining, based on a comparison, that the temperature exceeds an upper threshold temperature due to heat generation by a battery heater; and disconnecting, responsive to determining that the temperature exceeds an upper threshold temperature, the battery heater from a processing unit sufficient to deactivate the battery heater and suspend the heat generation.

In aspects, a method of a video-capturing doorbell is disclosed that includes: receiving a measurement indicative of a temperature of one or more regions proximate, adjacent, or internal to a battery; determining, responsive to receiving the measurement and based on a comparison, that the temperature exceeds an upper threshold temperature due to heat generation by a battery heater; and disconnecting, responsive to determining, the battery heater from a processing unit sufficient to deactivate the battery heater and suspend the heat generation.

This document also describes computer-readable media having instructions for performing the above-summarized methods and other methods set forth herein, as well as systems and means for performing the above method.

This summary is provided to introduce simplified concepts of context-based user interface, which are further described below in the Detailed Description. This summary is not intended to identify essential features of the claimed subject matter, nor is it intended for use in determining the scope of the claimed subject matter.

### BRIEF DESCRIPTION OF THE DRAWINGS

The details of one or more aspects of a battery heater failsafe circuit are described in this document with reference to the following drawings. The same numbers are used throughout the drawings to reference like features and components:

FIG. 1A is a representative network environment in which a battery heater failsafe circuit can be implemented in accordance with some implementations;

FIG. 1B illustrates the representative network environment in more detail;

FIG. 2A is a block diagram illustrating a representative network architecture that includes a home area network in accordance with some implementations;

FIG. 2B illustrates a representative operating environment in which a server system provides data processing for monitoring and facilitating review of events in video streams captured by cameras;

FIG. 3A is a block diagram illustrating the server system in accordance with some implementations;

FIG. 3B illustrates various data structures used by some implementations, including an event record, a user profile, a device profile, and characterization data;

FIG. 3C illustrates an example implementation of information associated with a user and/or a smart device;

FIG. 4A is a block diagram illustrating an example smart device in accordance with some implementations;

FIG. 4B illustrates a representative system architecture including video source(s), server system, and client device(s) in accordance with some implementations;

FIG. 5 is a block diagram illustrating a representative client device associated with a user account in accordance with some implementations;

FIG. 6 illustrates an isometric view of an example video-capturing doorbell in accordance with some implementations;

FIG. 7 illustrates a right elevational view of the example doorbell in FIG. 6, in accordance with some implementations;

FIG. 8 illustrates an exploded view of the example doorbell in FIG. 6;

FIG. 9 illustrates a portion of the exploded view of FIG. 8, showing a rear side of the heat sink, a main logic board (MLB) subassembly, and a battery subassembly in accordance with some implementations;

FIG. 10 illustrates an example thermal management subassembly and an example battery subassembly in greater detail in accordance with some implementations;

FIG. 11 illustrates an example method of the battery heater failsafe circuit in accordance with techniques described herein;

FIG. 12 illustrates an example method of the battery heater failsafe circuit in accordance with techniques described herein; and

FIG. 13 illustrates an example implementation of the battery heater failsafe circuit in accordance with systems and techniques described herein.

### DETAILED DESCRIPTION

The present document describes systems and techniques of a battery heater failsafe circuit of a video-capturing doorbell. In aspects, the video-capturing doorbell may be associated with a building (e.g., house, office, apartment, factory) and may be configured to provide smart features so as to operate interactively and/or autonomously (e.g., with little-to-no user oversight). Therefore, it is often desirable that these video-capturing doorbells are designed with a high degree of reliability and robustness. For instance, many video-capturing doorbells endure warm, humid environments, as well as freezing cold climates. To this end, specifically to enhance the reliability and robustness of video-capturing doorbells, a battery heater failsafe circuit may be configured to dynamically monitor a temperature of its battery (e.g., a battery pack), including one or more regions proximate, adjacent, or internal to the battery. In the event that while under software control of a main logic board, including a processing unit, a battery heater is activated and, due to a software malfunction, the temperature of the battery (or one of the proximate, adjacent, or internal regions) approaches or is equal to an upper threshold temperature, the battery heater failsafe circuit overrides the software-control of the battery heater to physically and/or electrically disconnect the battery heater from the processing unit and/or the battery. When the temperature of the one or more regions proximate, adjacent, or internal to the battery equals or drops below a lower threshold temperature, the battery heater failsafe circuit reconnects the battery heater to the processing unit and/or the battery sufficient to enable reactivation of the battery heater and enable heat generation by the battery heater.

While features and concepts of the described techniques for a battery heater failsafe circuit can be implemented in any number of different environments, aspects are described in the context of the following examples.

### Example Environment

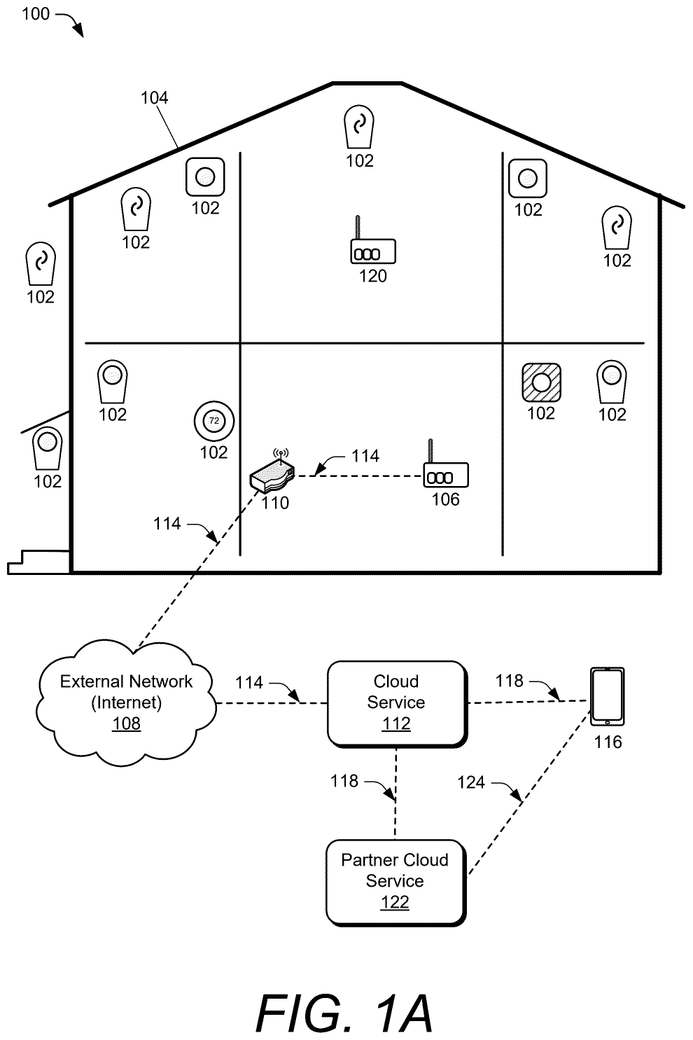

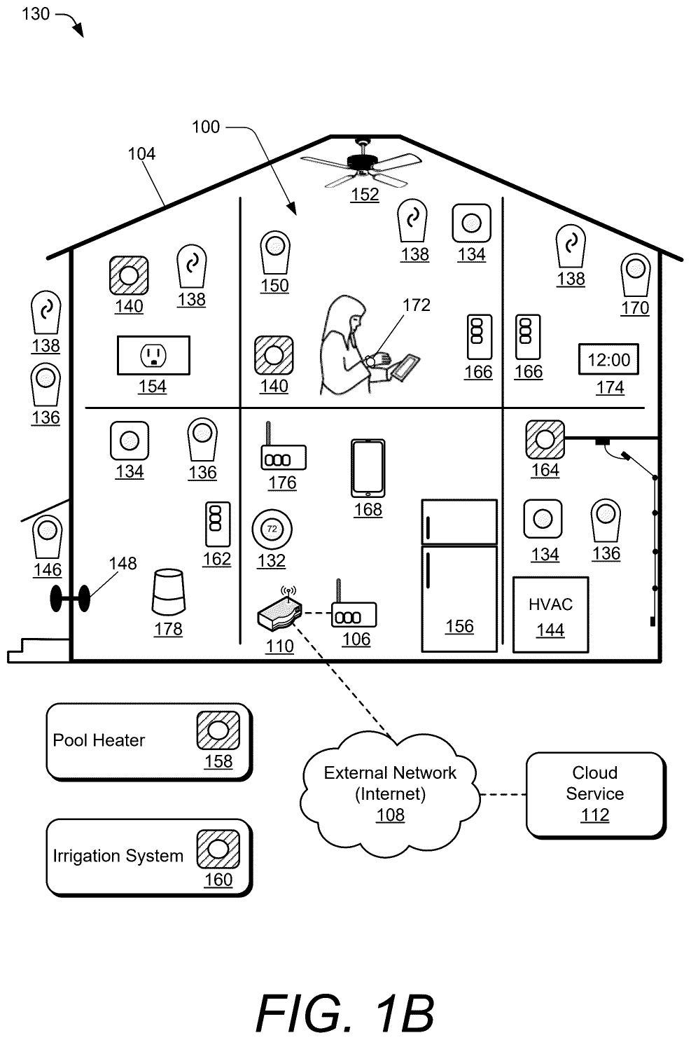

FIG. 1A illustrates an example network environment 100 (e.g., network environment) in which a battery heater failsafe circuit can be implemented. The network environment 100 includes a home area network (HAN). The HAN includes wireless network devices 102 (e.g., electronic devices) that are disposed about a structure 104, such as a house, and are connected by one or more wireless and/or wired network technologies, as described below. The HAN includes a border router 106 that connects the HAN to an external network 108, such as the Internet, through a home router or access point 110.

To provide user access to functions implemented using the wireless network devices 102 in the HAN, a cloud service 112 connects to the HAN via a border router 106, via a secure tunnel 114 through the external network 108 and the access point 110. The cloud service 112 facilitates communication between the HAN and internet clients 116, such as apps on mobile devices, using a web-based application programming interface (API) 118. The cloud service 112 also manages a home graph that describes connections and relationships between the wireless network devices 102, elements of the structure 104, and users. The cloud service 112 hosts controllers which orchestrate and arbitrate home automation experiences, as described in greater detail below.

The HAN may include one or more wireless network devices 102 that function as a hub 120. The hub 120 may be a general-purpose home automation hub, or an application-specific hub, such as a security hub, an energy management hub, a heating, ventilation, and air conditioning (HVAC) hub, and so forth. The functionality of a hub 120 may also be integrated into any wireless network device 102, such as a smart thermostat device or the border router 106. In addition to hosting controllers on the cloud service 112, controllers can be hosted on any hub 120 in the structure 104, such as the border router 106. A controller hosted on the cloud service 112 can be moved dynamically to the hub 120 in the structure 104, such as moving an HVAC zone controller to a newly installed smart thermostat.

Hosting functionality on the hub 120 in the structure 104 can improve reliability when the user's internet connection is unreliable, can reduce latency of operations that would normally have to connect to the cloud service 112, and can satisfy system and regulatory constraints around local access between wireless network devices 102.

The wireless network devices 102 in the HAN may be from a single manufacturer that provides the cloud service 112 as well, or the HAN may include wireless network devices 102 from partners. These partners may also provide partner cloud services 122 that provide services related to their wireless network devices 102 through a partner Web API 124. The partner cloud service 122 may optionally or additionally provide services to internet clients 116 via the web-based API 118, the cloud service 112, and the secure tunnel 114.

The network environment 100 can be implemented on a variety of hosts, such as battery-powered microcontroller-based devices, line-powered devices, and servers that host cloud services. Protocols operating in the wireless network devices 102 and the cloud service 112 provide a number of services that support operations of home automation experiences in a distributed computing environment (e.g., the network environment 100). These services include, but are not limited to, real-time distributed data management and subscriptions, command-and-response control, real-time event notification, historical data logging and preservation, cryptographically controlled security groups, time synchronization, network and service pairing, and software updates.

FIG. 1B illustrates an example environment 130 in which a home area network, as described with reference to FIG. 1A. Generally, the environment 130 includes the home area network (HAN) implemented as part of a home or other type of structure with any number of wireless network devices (e.g., wireless network devices 102) that are configured for communication in a wireless network. For example, the wireless network devices can include a thermostat 132, hazard detectors 134 (e.g., for smoke and/or carbon monoxide), cameras 136 (e.g., indoor and outdoor), lighting units 138 (e.g., indoor and outdoor), and any other types of wireless network devices 140 that are implemented inside and/or outside of the structure 104 (e.g., in a home environment). In this example, the wireless network devices 102 can also include any of the previously described devices, such as a border router 106, as well as a mobile device (e.g., smartphone) having the internet client 116.

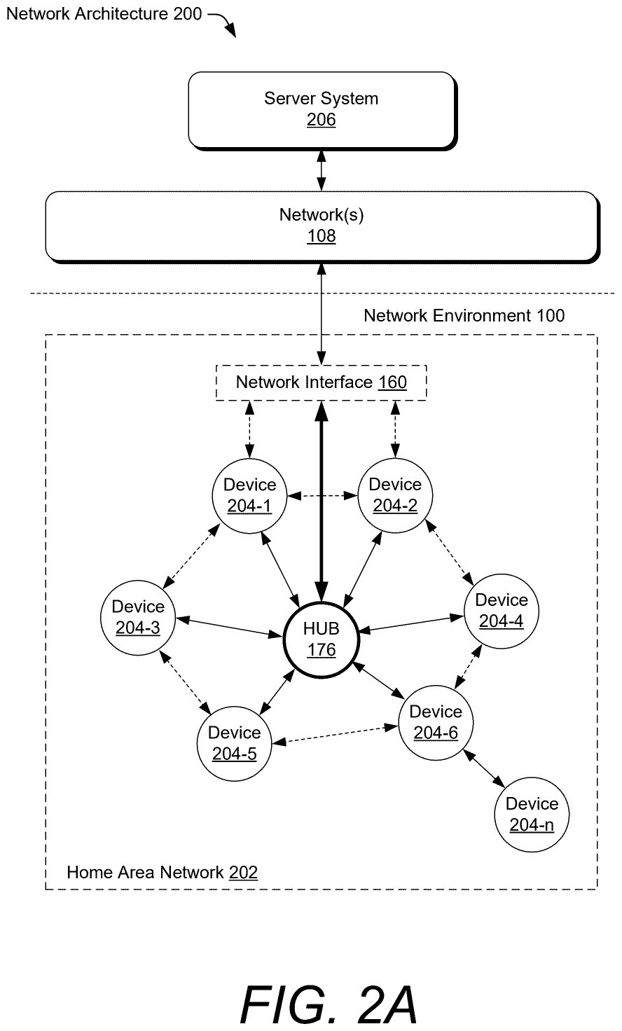

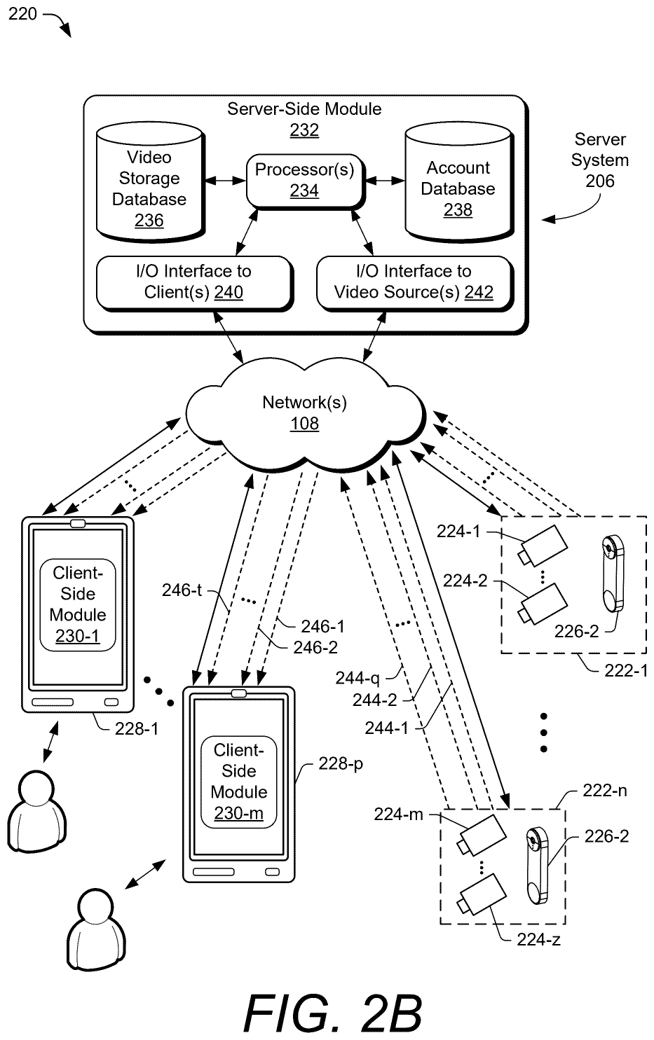

In the environment 130, any number of the wireless network devices can be implemented for wireless interconnection to wirelessly communicate and interact with each other. The wireless network devices are modular, intelligent, multi-sensing, network-connected devices that can integrate seamlessly with each other and/or with a central server or a cloud-computing system to provide any of a variety of useful automation objectives and implementations. An example of a wireless network device that can be implemented as any of the devices described herein is shown and described with reference to FIG. 2A.

In implementations, the thermostat 132 may include a Nest® Learning Thermostat that detects ambient climate characteristics (e.g., temperature and/or humidity) and controls an HVAC system 144 in the home environment. The learning thermostat 132 and other network-connected devices “learn” by capturing occupant settings to the devices. For example, the thermostat learns preferred temperature set-points for mornings and evenings, and when the occupants of the structure are asleep or awake, as well as when the occupants are typically away or at home.

A hazard detector 134 can be implemented to detect the presence of a hazardous substance or a substance indicative of a hazardous substance (e.g., smoke, fire, or carbon monoxide). In examples of wireless interconnection, a hazard detector 134 may detect the presence of smoke, indicating a fire in the structure, in which case the hazard detector that first detects the smoke can broadcast a low-power wake-up signal to all of the connected wireless network devices. The other hazard detectors 134 can then receive the broadcast wake-up signal and initiate a high-power state for hazard detection and to receive wireless communications of alert messages. Further, the lighting units 138 can receive the broadcast wake-up signal and activate in the region of the detected hazard to illuminate and identify the problem area. In another example, the lighting units 138 may activate in one illumination color to indicate a problem area or region in the structure, such as for a detected fire or break-in, and activate in a different illumination color to indicate safe regions and/or escape routes out of the structure.

In various configurations, the wireless network devices 140 can include an entryway interface device 146 that functions in coordination with a network-connected door lock system 148, and that detects and responds to a person's approach to or departure from a location, such as an outer door of the structure 104. The entryway interface device 146 can interact with the other wireless network devices based on whether someone has approached or entered the smart home environment. An entryway interface device 146 can control doorbell functionality, announce the approach or departure of a person via audio or visual means, and control settings on a security system, such as to activate or deactivate the security system when occupants come and go. The wireless network devices 140 can also include other sensors and detectors, such as to detect ambient lighting conditions, detect room-occupancy states (e.g., with an occupancy sensor 150), and control a power and/or dim state of one or more lights. In some instances, the sensors and/or detectors may also control a power state or speed of a fan, such as a ceiling fan 152. Further, the sensors and/or detectors may detect occupancy in a room or enclosure and control the supply of power to electrical outlets 154 or devices 140, such as if a room or the structure is unoccupied.

The wireless network devices 140 may also include connected appliances and/or controlled systems 156, such as refrigerators, stoves and ovens, washers, dryers, air conditioners, pool heaters 158, irrigation systems 160, security systems 162, and so forth, as well as other electronic and computing devices, such as televisions, entertainment systems, computers, intercom systems, garage-door openers 164, ceiling fans 152, control panels 166, and the like. When plugged in, an appliance, device, or system can announce itself to the home area network as described above and can be automatically integrated with the controls and devices of the home area network, such as in the home. It should be noted that the wireless network devices 140 may include devices physically located outside of the structure, but within wireless communication range, such as a device controlling a swimming pool heater 158 or an irrigation system 160.

As described above, the HAN includes a border router 106 that interfaces for communication with an external network, outside the HAN. The border router 106 connects to an access point 110, which connects to the external network 108, such as the Internet. A cloud service 112, which is connected via the external network 108, provides services related to and/or using the devices within the HAN. By way of example, the cloud service 112 can include applications for connecting end-user devices 168, such as smartphones, tablets, and the like, to devices in the home area network, processing and presenting data acquired in the HAN to end-users, linking devices in one or more HANs to user accounts of the cloud service 112, provisioning and updating devices in the HAN, and so forth. For example, a user can control the thermostat 132 and other wireless network devices in the home environment using a network-connected computer or portable device, such as a mobile phone or tablet device. Further, the wireless network devices can communicate information to any central server or cloud-computing system via the border router 106 and the access point 110. The data communications can be carried out using any of a variety of custom or standard wireless protocols (e.g., Wi-Fi, ZigBee for low power, 6LoWPAN, Thread, etc.) and/or by using any of a variety of custom or standard wired protocols (CAT6 Ethernet, HomePlug, and so on).

Any of the wireless network devices in the HAN can serve as low-power and communication nodes to create the HAN in the home environment. Individual low-power nodes of the network can regularly send out messages regarding what they are sensing, and the other low-powered nodes in the environment—in addition to sending out their own messages—can repeat the messages, thereby communicating the messages from node to node (e.g., from device to device) throughout the home area network. The wireless network devices can be implemented to conserve power, particularly when battery-powered, utilizing low-powered communication protocols to receive the messages, translate the messages to other communication protocols, and send the translated messages to other nodes and/or to a central server or cloud-computing system. For example, the occupancy sensor 150 and/or an ambient light sensor 170 can detect an occupant in a room as well as measure the ambient light, and activate the light source when the ambient light sensor 170 detects that the room is dark and when the occupancy sensor 150 detects that someone is in the room. Further, the sensor can include a low-power wireless communication chip (e.g., an Institute of Electrical and Electronics Engineers (IEEE) 802.15.4 chip, a Thread chip, a ZigBee chip) that regularly sends out messages regarding the occupancy of the room and the amount of light in the room, including instantaneous messages coincident with the occupancy sensor detecting the presence of a person in the room. As mentioned above, these messages may be sent wirelessly, using the home area network, from node to node (e.g., network-connected device to network-connected device) within the home environment as well as over the Internet to a central server or cloud-computing system.

In other configurations, various ones of the wireless network devices can function as “tripwires” for an alarm system in the home environment. For example, in the event a perpetrator circumvents detection by alarm sensors located at windows, doors, and other entry points of the structure or environment, the alarm could still be triggered by receiving an occupancy, motion, heat, sound, etc. message from one or more of the low-powered mesh nodes in the home area network. In other implementations, the home area network can be used to automatically turn on and off the lighting units 138 as a person transitions from room to room in the structure. For example, the wireless network devices can detect the person's movement through the structure and communicate corresponding messages via the nodes of the home area network. Using the messages that indicate which rooms are occupied, other wireless network devices that receive the messages can activate and/or deactivate accordingly. As referred to above, the home area network can also be utilized to provide exit lighting in the event of an emergency, such as by turning on the appropriate lighting units 138 that lead to a safe exit. The lighting units 138 may also be turned on to indicate the direction along an exit route that a person should travel to safely exit the structure.

The various wireless network devices may also be implemented to integrate and communicate with wearable computing devices 172, such as may be used to identify and locate an occupant of the structure and adjust the temperature, lighting, sound system, and the like accordingly. In other implementations, radio-frequency identification (RFID) sensing (e.g., a person having an RFID bracelet, necklace, or key fob), synthetic vision techniques (e.g., video cameras and face recognition processors), audio techniques (e.g., voice, sound pattern, vibration pattern recognition), ultrasound sensing/imaging techniques, and infrared or near-field communication (NFC) techniques (e.g., a person wearing an infrared or NFC-capable smartphone), along with rules-based inference engines or artificial intelligence techniques can draw useful conclusions from the sensed information as to the location of an occupant in the structure or environment.

In other implementations, personal comfort-area networks, personal health-area networks, personal safety-area networks, and/or other such human-facing functionalities of service robots can be enhanced by logical integration with other wireless network devices and sensors in the environment according to rules-based inferencing techniques or artificial intelligence techniques for achieving better performance of these functionalities. In an example relating to a personal health area, the system can detect whether a household pet is moving toward the current location of an occupant (e.g., using any of the wireless network devices and sensors), along with rules-based inferencing and artificial intelligence techniques. Similarly, a hazard detector service robot can be notified that the temperature and humidity levels are rising in a kitchen, and temporarily raise a hazard detection threshold, such as a smoke detection threshold, under an inference that any small increases in ambient smoke levels will most likely be due to cooking activity and not due to a genuinely hazardous condition. Any service robot that is configured for any type of monitoring, detecting, and/or servicing can be implemented as a mesh node device on the home area network, conforming to the wireless interconnection protocols for communicating on the home area network.

The wireless network devices 140 may also include a network-connected alarm clock 174 for each of the individual occupants of the structure in the home environment. For example, an occupant can customize and set an alarm device for a wake time, such as for the next day or week. Artificial intelligence can be used to consider occupant responses to the alarms when they go off and make inferences about preferred sleep patterns over time. An individual occupant can then be tracked in the home area network based on a unique signature of the person, which is determined based on data obtained from sensors located in the wireless network devices, such as sensors that include ultrasonic sensors, passive IR sensors, and the like. The unique signature of an occupant can be based on a combination of patterns of movement, voice, height, size, etc., as well as using facial recognition techniques.

In an example of wireless interconnection, the wake time for an individual can be associated with the thermostat 132 to control the HVAC system in an efficient manner so as to pre-heat or cool the structure to desired sleeping and awake temperature settings. The preferred settings can be learned over time, such as by capturing the temperatures set in the thermostat before the person goes to sleep and upon waking up. Collected data may also include biometric indications of a person, such as breathing patterns, heart rate, movement, etc., from which inferences are made based on this data in combination with data that indicates when the person actually wakes up. Other wireless network devices can use the data to provide other automation objectives, such as adjusting the thermostat 132 so as to pre-heat or cool the environment to a desired setting and turning on or turning off the lighting units 138.

In implementations, the wireless network devices can also be utilized for sound, vibration, and/or motion sensing such as to detect running water and determine inferences about water usage in a home environment based on algorithms and mapping of the water usage and consumption. This can be used to determine a signature or fingerprint of each water source in the home and is also referred to as “audio fingerprinting water usage.” Similarly, the wireless network devices can be utilized to detect the subtle sound, vibration, and/or motion of unwanted pests, such as mice and other rodents, as well as by termites, cockroaches, and other insects. The system can then notify an occupant of the suspected pests in the environment, such as with warning messages to help facilitate early detection and prevention.

The environment 130 may include one or more wireless network devices that function as a hub 176. The hub 176 (e.g., hub 120) may be a general-purpose home automation hub, or an application-specific hub, such as a security hub, an energy management hub, an HVAC hub, and so forth. The functionality of a hub 176 may also be integrated into any wireless network device, such as a network-connected thermostat device or the border router 106. Hosting functionality on the hub 176 in the structure 104 can improve reliability when the user's internet connection is unreliable, can reduce latency of operations that would normally have to connect to the cloud service 112, and can satisfy system and regulatory constraints around local access between wireless network devices.

Additionally, the example environment 130 includes a network-connected speaker 178. The network-connected speaker 178 provides voice assistant services that include providing voice control of network-connected devices. The functions of the hub 176 may be hosted in the network-connected speaker 178. The network-connected speaker 178 can be configured to communicate via the HAN, which may include a wireless mesh network, a Wi-Fi network, or both.

FIG. 2A is a block diagram illustrating a representative network architecture 200 that includes a home area network 202 (HAN 202) in accordance with some implementations. In some implementations, smart devices 204 (e.g., wireless network devices 102) in the network environment 100 combine with the hub 176 to create a mesh network in the HAN 202. In some implementations, one or more of the smart devices 204 in the HAN 202 operate as a smart home controller. Additionally and/or alternatively, the hub 176 may operate as the smart home controller. In some implementations, a smart home controller has more computing power than other smart devices. The smart home controller can process inputs (e.g., from smart devices 204, end-user devices 168, and/or server system 206) and send commands (e.g., to smart devices 204 in the HAN 202) to control operation of the network environment 100. In aspects, some of the smart devices 204 in the HAN 202 (e.g., in the mesh network) are “spokesman” nodes (e.g., 204-1, 204-2) and others are “low-powered” nodes (e.g., 204-n). Some of the smart devices in the network environment 100 may be battery-powered, while others may have a regular and reliable power source, such as via line power (e.g., to 120V line voltage wires). The smart devices that have a regular and reliable power source are referred to as “spokesman” nodes. These nodes are typically equipped with the capability of using a wireless protocol to facilitate bidirectional communication with a variety of other devices in the network environment 100, as well as with the server system 206 (e.g., cloud service 112, partner cloud service 122). In some implementations, one or more “spokesman” nodes operate as a smart home controller. On the other hand, the devices that are battery-powered are the “low-power” nodes. These nodes tend to be smaller than spokesman nodes and typically only communicate using wireless protocols that require very little power, such as Zigbee, ZWave, 6LoWPAN, Thread, Bluetooth, etc.

Some low-power nodes may be incapable of bidirectional communication. These low-power nodes send messages but are unable to “listen”. Thus, other devices in the network environment 100, such as the spokesman nodes, cannot send information to these low-power nodes.

Some low-power nodes may be capable of only a limited bidirectional communication. As a result of such limited bidirectional communication, other devices may be able to communicate with these low-power nodes only during a certain time period.

As described, in some implementations, the smart devices serve as low-power and spokesman nodes to create a mesh network in the network environment 100. In some implementations, individual low-power nodes in the network environment regularly send out messages regarding what they are sensing, and the other low-powered nodes in the network environment—in addition to sending out their own messages—forward the messages, thereby causing the messages to travel from node to node (e.g., device to device) throughout the HAN 202. In some implementations, the spokesman nodes in the HAN 202, which are able to communicate using a relatively high-power communication protocol (e.g., IEEE 802.11), are able to switch to a relatively low-power communication protocol (e.g., IEEE 802.15.4) to receive these messages, translate the messages to other communication protocols, and send the translated messages to other spokesman nodes and/or the server system 206 (using, e.g., the relatively high-power communication protocol). Thus, the low-powered nodes using low-power communication protocols are able to send and/or receive messages across the entire HAN 202, as well as over the Internet (e.g., network 108) to the server system 206. In some implementations, the mesh network enables the server system 206 to regularly receive data from most or all of the smart devices in the home, make inferences based on the data, facilitate state synchronization across devices within and outside of the HAN 202, and send commands to one or more of the smart devices to perform tasks in the network environment.

As described, the spokesman nodes and some of the low-powered nodes are capable of “listening.” Accordingly, users, other devices, and/or the server system 206 may communicate control commands to the low-powered nodes. For example, a user may use the end-user device 168 (e.g., a smart phone) to send commands over the Internet to the server system 206, which then relays the commands to one or more spokesman nodes in the HAN 202. The spokesman nodes may use a low-power protocol to communicate the commands to the low-power nodes throughout the HAN 202, as well as to other spokesman nodes that did not receive the commands directly from the server system 206.

In some implementations, a lighting unit 138 (FIG. 1B), which is an example of a smart device 204, may be a low-power node. In addition to housing a light source, the lighting unit 138 may house an occupancy sensor (e.g., occupancy sensor 150), such as an ultrasonic or passive IR sensor, and an ambient light sensor (e.g., ambient light sensor 170), such as a photo resistor or a single-pixel sensor that measures light in the room. In some implementations, the lighting unit 138 is configured to activate the light source when its ambient light sensor detects that the room is dark and when its occupancy sensor detects that someone is in the room. In other implementations, the lighting unit 138 is simply configured to activate the light source when its ambient light sensor detects that the room is dark. Further, in some implementations, the lighting unit 138 includes a low-power wireless communication chip (e.g., a ZigBee chip) that regularly sends out messages regarding the occupancy of the room and the amount of light in the room, including instantaneous messages coincident with the occupancy sensor detecting the presence of a person in the room. As mentioned above, these messages may be sent wirelessly (e.g., using the mesh network) from node to node (e.g., smart device to smart device) within the HAN 202 as well as over the network 108 (e.g., the Internet) to the server system 206.

Other examples of low-power nodes include battery-operated versions of the hazard detectors 134. These hazard detectors 134 are often located in an area without access to constant and reliable power and may include any number and type of sensors, such as smoke/fire/heat sensors (e.g., thermal radiation sensors), carbon monoxide/dioxide sensors, occupancy/motion sensors, ambient light sensors, ambient temperature sensors, humidity sensors, and the like. Furthermore, hazard detectors 134 may send messages that correspond to each of the respective sensors to the other devices and/or the server system 206, such as by using the mesh network as described above.

Examples of spokesman nodes include entryway interface devices 146 (e.g., smart doorbells), thermostats 132, control panels 166, electrical outlets 154, and other wireless network devices 140. These devices are often located near and connected to a reliable power source, and therefore may include more power-consuming components, such as one or more communication chips capable of bidirectional communication in a variety of protocols.

In some implementations, the network environment 100 includes controlled systems 156, such as service robots, that are configured to carry out, in an autonomous manner, any of a variety of household tasks.

As explained with reference to FIG. 1B, in some implementations, the network environment 100 includes a hub device (e.g., hub 176) that is communicatively coupled to the network(s) 108 directly or via a network interface 208 (e.g., access point 110). The hub 176 is further communicatively coupled to one or more of the smart devices 204 using a radio communication network that is available at least in the network environment 100. Communication protocols used by the radio communication network include, but are not limited to, ZigBee, Z-Wave, Insteon, EuOcean, Thread, OSIAN, Bluetooth Low Energy, and the like. In some implementations, the hub 176 not only converts the data received from each smart device to meet the data format requirements of the network interface 208 or the network(s) 108, but also converts information received from the network interface 208 or the network(s) 108 to meet the data format requirements of the respective communication protocol associated with a targeted smart device. In some implementations, in addition to data format conversion, the hub 176 further processes the data received from the smart devices or information received from the network interface 208 or the network(s) 108 preliminary. For example, the hub 176 can integrate inputs from multiple sensors/connected devices (including sensors/devices of the same and/or different types), perform higher-level processing on those inputs—e.g., to assess the overall environment and coordinate operation among the different sensors/devices—and/or provide instructions to the different devices based on the collection of inputs and programmed processing. It is also noted that in some implementations, the network interface 208 and the hub 176 are integrated into one network device. Functionality described herein is representative of particular implementations of smart devices, control application(s) running on representative electronic device(s) (such as a smart phone), hub(s) 176, and server system(s) 206 coupled to hub(s) 176 via the Internet or other Wide Area Network. All or a portion of this functionality and associated operations can be performed by any elements of the described system—for example, all or a portion of the functionality described herein as being performed by an implementation of the hub can be performed, in different system implementations, in whole or in part on the server, one or more connected smart devices and/or the control application, or different combinations thereof.

FIG. 2B illustrates a representative operating environment 220 in which a server system 206 provides data processing for monitoring and facilitating review of events (e.g., motion, audio, security, etc.) in video streams captured by cameras 136 (e.g., video cameras, doorbell cameras). As shown in FIG. 2B, the server system 206 receives video data from video sources 222 (including video cameras 224 or video-capturing doorbell devices 226) located at various physical locations (e.g., inside or in proximity to homes, restaurants, stores, streets, parking lots, and/or the network environments 100 of FIG. 1). Each video source 222 may be linked to one or more reviewer accounts, and the server system 206 provides video monitoring data for the video source 222 to client devices 228 associated with the reviewer accounts. For example, the portable end-user device 168 is an example of the client device 228. In some implementations, the server system 206 is a video processing server that provides video processing services to the video sources and client devices 228.

In some implementations, the server system 206 receives non-video data from one or more smart devices 204 (e.g., audio data, metadata, numerical data, etc.). The non-video data may be analyzed to provide context for motion events detected by the video cameras 224 and/or the video-capturing doorbell devices 226. In some implementations, the non-video data indicates that an audio event (e.g., detected by an audio device such as an audio sensor integrated into the network-connected speaker 178), a security event (e.g., detected by a perimeter monitoring device such as the camera 136 and/or a motion sensor), a hazard event (e.g., detected by the hazard detector 134), medical event (e.g., detected by a health-monitoring device), or the like has occurred within a network environment 100.

In some implementations, multiple reviewer accounts are linked to a single network environment 100. For example, multiple occupants of a network environment 100 may have accounts linked to the network environment 100. In some implementations, each reviewer account is associated with a particular level of access. In some implementations, each reviewer account has personalized notification settings. In some implementations, a single reviewer account is linked to multiple network environments 100 (e.g., multiple different HANs). For example, a person may own or occupy, or be assigned to review and/or govern, multiple network environments 100. In some implementations, the reviewer account has distinct levels of access and/or notification settings for each network environment.

In some implementations, each of the video sources 222 includes one or more video cameras 224 or video-capturing doorbell devices 226 that capture video and send the captured video to the server system 206 substantially in real-time. In some implementations, each of the video sources 222 includes one or more doorbell devices 226 that capture video and send the captured video to the server system 206 in real-time (e.g., within 1 second, 10 seconds, 30 seconds, or 1 minute). Each of the doorbell devices 226 may include a video camera that captures video and sends the captured video to the server system 206 in real-time. In aspects, a video source 222 includes a controller device (not shown) that serves as an intermediary between the one or more doorbell devices 226 and the server system 206. The controller device receives the video data from the one or more doorbell devices 226, optionally performs some preliminary processing on the video data, and sends the video data and/or the results of the preliminary processing to the server system 206 on behalf of the one or more doorbell devices 226 (e.g., in real-time). In some implementations, each camera has its own on-board processing capabilities to perform some preliminary processing on the captured video data before sending the video data (e.g., along with metadata obtained through the preliminary processing) to the controller device and/or the server system 206. In some implementations, one or more of the cameras is configured to, optionally, locally store the video data (e.g., for later transmission if requested by a user). In some implementations, a camera is configured to perform some processing of the captured video data and based on the processing, either send the video data in substantially real-time, store the video data locally, or disregard the video data.

In accordance with some implementations, a client device 228 includes a client-side module 230. In some implementations, the client-side module communicates with a server-side module 232 executed on the server system 206 through the one or more networks 108. The client-side module provides client-side functionality for the event monitoring and review processing and communications with the server-side module. The server-side module provides server-side functionality for event monitoring and review processing for any number of client-side modules each residing on a respective client device 228 (e.g., any one of client devices 228-1 to 228-m). In some implementations, the server-side module 232 also provides server-side functionality for video processing and camera control for any number of the video sources 222, including any number of control devices, cameras 136, and doorbell devices 226.

In some implementations, the server system 206 includes one or more processors 234, a video storage database 236, an account database 238, an input/output (I/O) interface 240 to one or more client devices 228, and an I/O interface 242 to one or more video sources 222. The I/O interface 242 to one or more client devices 228 facilitates the client-facing input and output processing. The account database 238 stores a plurality of profiles for reviewer accounts registered with the video processing server, where a respective user profile includes account credentials for a respective reviewer account, and one or more video sources linked to the respective reviewer account. The I/O interface 242 to one or more video sources 222 facilitates communications with one or more video sources 222 (e.g., groups of one or more doorbell devices 226, cameras 136, and associated controller devices). The video storage database 236 stores raw video data received from the video sources 222, as well as various types of metadata, such as motion events, event categories, event categorization models, event filters, and event masks, for use in data processing for event monitoring and review for each reviewer account.

Examples of a representative client device 228 include a handheld computer, a wearable computing device, a personal digital assistant (PDA), a tablet computer, a laptop computer, a desktop computer, a cellular telephone, a smart phone, an enhanced general packet radio service (EGPRS) mobile phone, a media player, a navigation device, a game console, a television, a remote control, a point-of-sale (POS) terminal, a vehicle-mounted computer, an eBook reader, or a combination of any two or more of these data processing devices or other data processing devices.

Examples of the one or more networks 108 include local area networks (LAN) and wide-area networks (WAN) such as the Internet. The one or more networks 108 are implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

In some implementations, the server system 206 is implemented on one or more standalone data processing apparatuses or a distributed network of computers. The server system 206 may also employ various virtual devices and/or services of third-party service providers (e.g., third-party cloud service providers) to provide the underlying computing resources and/or infrastructure resources of the server system 206. In some implementations, the server system 206 includes, but is not limited to, a server computer, a handheld computer, a tablet computer, a laptop computer, a desktop computer, or a combination of any two or more of these data processing devices or other data processing devices.

The server-client environment shown in FIG. 2B includes both a client-side portion (e.g., the client-side module) and a server-side portion (e.g., the server-side module). The division of functionality between the client and server portions of an operating environment can vary in different implementations. Similarly, the division of functionality between a video source 222 and the server system 206 can vary in different implementations. For example, in some implementations, the client-side module is a thin client that provides only user-facing input and output processing functions, and delegates all other data processing functionality to a backend server (e.g., the server system 206). Similarly, in some implementations, a respective one of the video sources 222 is a simple video capturing device that continuously captures and streams (e.g., continuous video recording (CVR)) video data to the server system 206 with limited or no local preliminary processing on the video data. In some implementations, a respective one of the video sources 222 is a smart video capturing device that captures and streams video data to the server system 206 in response to detection of an event (e.g., event-based recording (EBR)). Although many aspects of the present technology are described from the perspective of the server system 206, the corresponding actions performed by a client device 228 and/or the video sources 222 would be apparent to one of skill in the art. Similarly, some aspects of the present technology may be described from the perspective of a client device or a video source, and the corresponding actions performed by the video server would be apparent to one of skill in the art. Furthermore, some aspects of the present technology may be performed by the server system 206, a client device 228, and a video source 222 cooperatively.

In some aspects, a video source 222 (e.g., a video camera 224 or a doorbell device 226 having an image sensor) transmits one or more streams 244 of video data to the server system 206. In some implementations, the one or more streams include multiple streams, having respective resolutions and/or frame rates, of the raw video captured by the image sensor. In some implementations, the multiple streams include a “primary” stream (e.g., 244-1) with a certain resolution and frame rate, corresponding to the raw video captured by the image sensor, and one or more additional streams (e.g., 244-2 through 244-q). An additional stream is optionally the same video stream as the “primary” stream but at a different resolution and/or frame rate, or a stream that captures a portion of the “primary” stream (e.g., cropped to include a portion of the field of view or pixels of the primary stream) at the same or different resolution and/or frame rate as the “primary” stream. In some implementations, the primary stream and/or the additional streams are dynamically encoded (e.g., based on network conditions, server operating conditions, camera operating conditions, characterization of data in the stream, such as whether motion is present, user preferences, and the like).

In some implementations, one or more of the streams 244 is sent from the video source 222 directly to a client device 228 (e.g., without being routed to, or processed by, the server system 206). In some implementations, one or more of the streams is stored at a local memory of the doorbell device 226 and/or at a local storage device (e.g., a dedicated recording device), such as a digital video recorder (DVR). For example, in accordance with some implementations, the doorbell device 226 stores the most-recent 24 hours of video footage recorded by the camera. In some implementations, portions of the one or more streams are stored at the doorbell device 226 and/or the local storage device (e.g., portions corresponding to particular events or times of interest).

In some implementations, the server system 206 transmits one or more streams 246 of video data to a client device 228 to facilitate event monitoring by a user. In some implementations, the one or more streams may include multiple streams, of respective resolutions and/or frame rates, of the same video feed. In some implementations, the multiple streams include a “primary” stream (e.g., 246-1) with a certain resolution and frame rate, corresponding to the video feed, and one or more additional streams (e.g., 246-2 through 246-t). An additional stream may be the same video stream as the “primary” stream but at a different resolution and/or frame rate, or a stream that shows a portion of the “primary” stream (e.g., cropped to include a portion of the field of view or pixels of the primary stream) at the same or different resolution and/or frame rate as the “primary” stream.

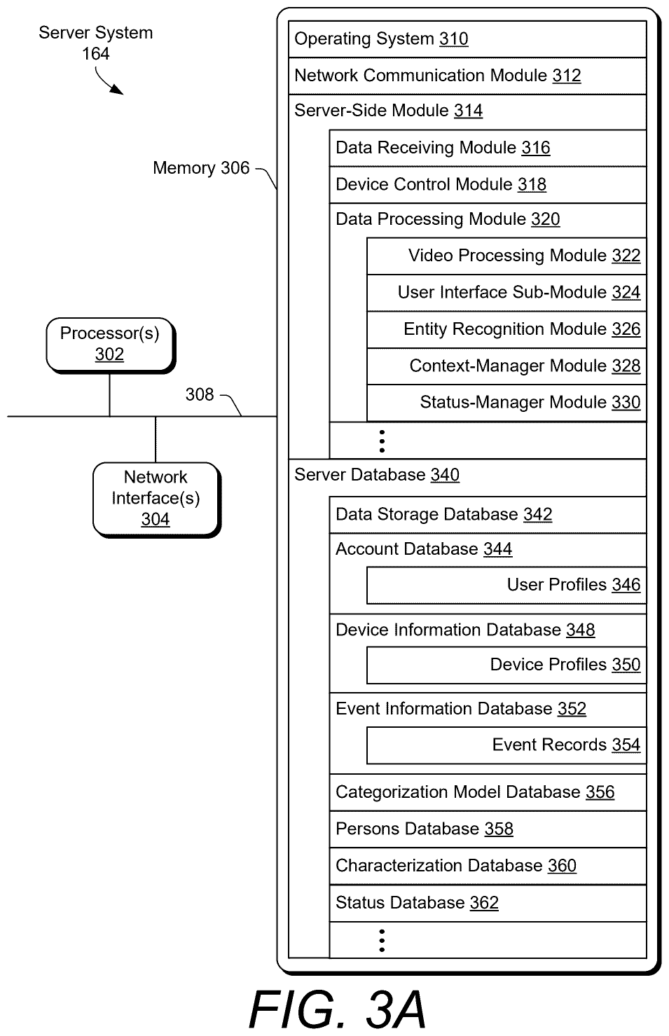

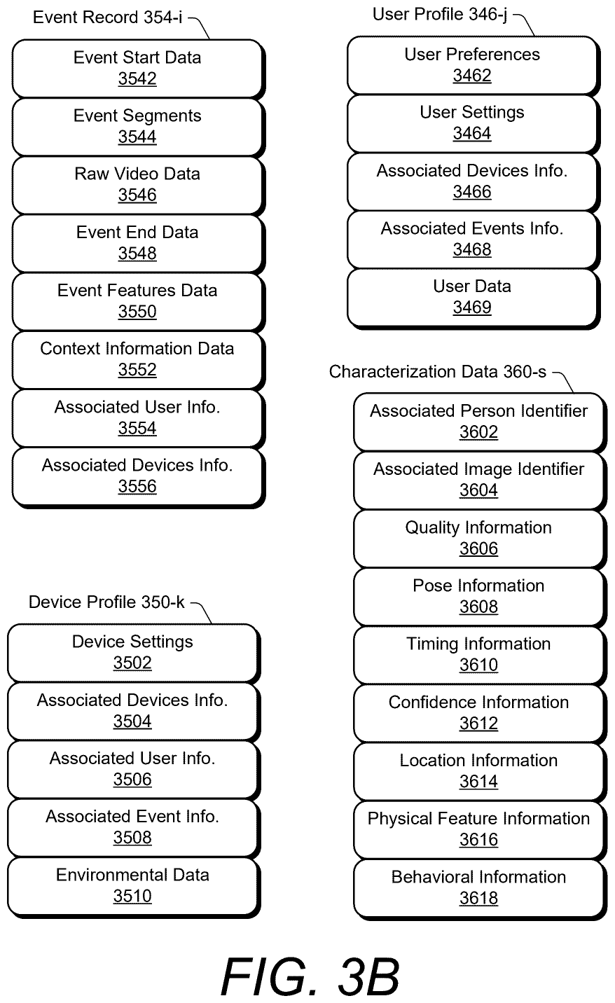

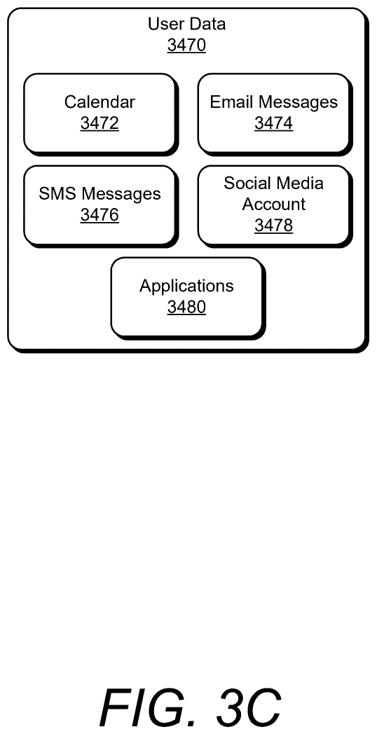

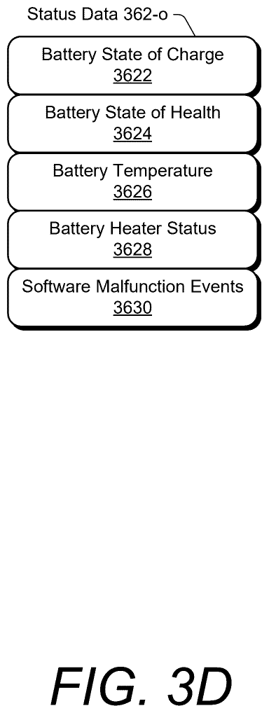

FIG. 3A is a block diagram illustrating the server system 206 in accordance with some implementations. The server system 206 typically includes one or more processors 302, one or more network interfaces 304 (e.g., including the I/O interface 240 to one or more client devices and the I/O interface 242 to one or more electronic devices), memory 306, and one or more communication buses 308 for interconnecting these components (sometimes called a chipset). The memory 306 includes high-speed random access memory, such as DRAM, SRAM, DDR SRAM, or other random access solid-state memory devices; and, optionally, includes non-volatile memory, such as one or more magnetic disk storage devices, one or more optical disk storage devices, one or more flash memory devices, or one or more other non-volatile solid-state storage devices. The memory 306, optionally, includes one or more storage devices remotely located from one or more of the processors 302. The memory 306, or alternatively the non-volatile memory within memory 306, includes a non-transitory computer-readable storage medium. In some implementations, the memory 306, or the non-transitory computer-readable storage medium of the memory 306, stores the following programs, modules, and data structures, or a subset or superset thereof:
an operating system 310 including procedures for handling various basic system services and for performing hardware-dependent tasks;
a network communication module 312 for connecting the server system 206 to other systems and devices (e.g., client devices, electronic devices, and systems connected to one or more networks 108) via one or more network interfaces 304 (wired or wireless);
a server-side module 314 (e.g., server-side module 232), which provides server-side functionalities for device control, data processing, and data review, including, but not limited to:
   a data receiving module 316 for receiving data from electronic devices (e.g., video data from a doorbell device 226, status data from a doorbell device 226), and preparing the received data for further processing and storage in a data storage database (e.g., data storage database 342);
   a device control module 318 for generating and sending server-initiated control commands to modify operation modes of electronic devices (e.g., devices of a network environment 100), and/or receiving (e.g., from client devices 228) and forwarding user-initiated control commands to modify operation modes of the electronic devices;
   a data processing module 320 for processing the data provided by the electronic devices, and/or preparing and sending processed data to a device for review (e.g., client devices 228 for review by a user), including, but not limited to:
      a video processing module 322 for processing (e.g., categorizing and/or recognizing) detected entities and/or event candidates within a received video stream (e.g., a video stream from doorbell device 226);
      a user interface sub-module 324 for communicating with a user (e.g., sending alerts, timeline events, etc. and receiving user edits and zone definitions and the like);
      an entity recognition module 326 for analyzing and/or identifying persons detected within network environments;
      a context-manager module 328 for determining contexts, or estimating possible contexts, of persons detected within network environments and context-based options associated with determined or estimated contexts; and
      a status-manager module 330 for determining and/or identifying a condition of an electronic device (e.g., doorbell device 226) based on an analysis of received status data; and
a server database 340, including but not limited to:
   data storage database 342 for storing data associated with each electronic device (e.g., each doorbell) of each user account, as well as data processing models, processed data results, and other relevant metadata (e.g., names of data results, location of electronic device, creation time, duration, settings of the electronic device, etc.) associated with the data, where (optionally) all or a portion of the data and/or processing associated with the hub 176 or smart devices are stored securely;
   an account database 344 for storing account information for user accounts, including user account information such as user profiles 346, information and settings for linked hub devices and electronic devices (e.g., hub device identifications), hub device-specific secrets, relevant user and hardware characteristics (e.g., service tier, device model, storage capacity, processing capabilities, etc.), user interface settings, data review preferences, etc., where the information for associated electronic devices includes, but is not limited to, one or more device identifiers (e.g., a media access control (MAC) address and universally unique identifier (UUID)), device-specific secrets, and displayed titles;
   a device information database 348 for storing device information related to one or more devices such as device profiles 350, e.g., device identifiers and hub device-specific secrets, independently of whether the corresponding hub devices have been associated with any user account;
   an event information database 352 for storing event information such as event records 354 and context information, e.g., context-based data describing circumstances surrounding an approaching guest;
   a categorization model database 356 for storing event categorization models related to event categories for categorizing events detected by, or involving, the smart device;
   a person's database 358 for storing information regarding detected and/or recognized persons, such as images (e.g., cropped headshots) of detected persons and feature characterization data for the persons;
   a characterization database 360 for use with characterizing motion, persons, and events within the network environment, e.g., in conjunction with the data processing module 320; and
   a status database 362 for storing status data related to a condition of an electronic device (e.g., a battery heater failsafe circuit physically and/or electrically disconnecting a battery heater from a processing unit and/or a battery), a battery temperature as measured by a thermistor exceeding an upper threshold temperature, and/or a battery temperature as measured by a thermistor dropping below a lower threshold temperature.

Each of the above-identified elements may be stored in one or more of the previously mentioned memory devices and may correspond to a set of instructions for performing a function described above. The above-identified modules or programs (e.g., sets of instructions) need not be implemented as separate software programs, procedures, or modules, and thus various subsets of these modules may be combined or otherwise rearranged in various implementations. In some implementations, the memory 306, optionally, stores a subset of the modules and data structures identified above. Furthermore, the memory 306, optionally, stores additional modules and data structures not described above.

FIG. 3B illustrates various data structures used by some implementations, including an event record 354-i, a user profile 346-j, a device profile 350-k, and characterization data 360-s. The event record 354-i corresponds to an event T and data for the event T. In some implementations, the event T includes one or more of: a motion event, a hazard event, a medical event, a power event, an audio event, and a security event. In some instances, the data for a motion event T includes event start data 3542 indicating when and/or how the event started, event segments data 3544, raw video data 3546, event end data 3548 indicating when and/or how the event ended, event features data 3550, context information data 3552, associated user information 3554 (e.g., user participating in the event and/or users associated with the network environment in which the event took place), and associated devices information 3556. In some instances, the event record 354-i includes only a subset of the above data. In some instances, the event record 354-i includes additional event data not shown such as data regarding event/motion masks.

The event start data 3542 includes date and time information such as a timestamp and optionally includes additional information such as information regarding the amount of motion present, a motion start location, amount of audio present, characteristics of the audio, and the like. Similarly, the event end data 3548 includes date and time information such as a timestamp and optionally includes additional information such as information regarding the amount of motion present, a motion start location, amount of audio present, characteristics of the audio, and the like.

The event segments data 3544 includes information regarding segmentation of the motion event T. In some instances, event segments are stored separately from the video data 3546. In some instances, the event segments are stored at a different (lower) display resolution than the video data. For example, the event segments are optionally stored at 482p or 780p and the video data is stored at 1080i or 1080p. Storing the event segments at a lower display resolution enables the system to devote less time and resources to retrieving and processing the event segments. In some instances, the event segments are not stored separately, and the segmentation information includes references to the video data 3546 as well as date and time information for reproducing the event segments. In some implementations, the event segments include one or more audio segments (e.g., corresponding to video segments).

The event features data 3550 includes information regarding event features such as event categorizations/classifications, object masks, motion masks, identified/recognized/tracked motion objects (also sometimes called blobs), information regarding features of the motion objects (e.g., object color, object dimensions, velocity, size changes, etc.), information regarding activity in zones of interest, and the like.

The context information data 3552 includes context information regarding the event such as information regarding the guest (e.g., behavior, clothing, or size characteristics), information regarding approach timing (e.g., time of day, level of brightness), information regarding guest announcements (e.g., doorbell press, knocking, and associated timing thereof), information regarding scheduling (e.g., proximity in time to a prescheduled event, or proximity in time to a prescheduled status of the network environment), information regarding the status or location of one or more users, and the like.

The associated user information 3554 includes information regarding users associated with the event such as users identified in the event, users receiving notification of the event, and the like. In some instances, the associated user information 3554 includes a link, pointer, or reference to a user profile 346 for the user. The associated devices information 3556 includes information regarding the device or devices involved in the event (e.g., a doorbell device 226 that recorded the event). In some instances, the associated devices information 3556 includes a link, pointer, or reference to a device profile 350 for the device.

The user profile 346-j corresponds to a user ‘j’ associated with the network environment 100 (e.g., HAN 202) such as a user of a smart device 204, a user identified by a smart device 204, a user who receives notifications from a smart device 204 or from the server system 206, and the like. In some instances, the user profile 346-j includes user preferences 3464, user settings 3466, associated devices information 3468, associated events information 3470, and user data 3469. In some instances, the user profile 346-j includes only a subset of the above data. In some instances, the user profile 346-j includes additional user information not shown, such as information regarding other users associated with the user ‘j’ and/or information regarding network environments linked to the user.

The user preferences 3464 include explicit user preferences input by the user as well as implicit and/or inferred user preferences determined by the system (e.g., server system 206 and/or client device 228). In some instances, the inferred user preferences are based on historical user activity and/or historical activity of other users. The user settings 3466 include information regarding settings set by the user ‘j’ such as notification settings, device settings, and the like. In some instances, the user settings 3466 include device settings for devices associated with the user ‘j’.

The associated devices information 3468 includes information regarding devices associated with the user ‘j’ such as devices within the user's network environment(s) 100 and/or client device(s) 228. In some instances, associated devices information 3468 includes a link, pointer, or reference to a corresponding device profile 350. Associated events information 3470 includes information regarding events associated with user ‘j’ such as events in which user ‘j’ was identified, events for which user ‘j’ was notified, events corresponding to a network environment 100 of user ‘j,’ and the like. In some instances, the associated events information 3470 includes a link, pointer, or reference to a corresponding event record 354.

The user data 3469 is described in more detail in FIG. 3C, which illustrates an example implementation of information that is associated with a user and/or a smart device 204. The user data 3469 includes information usable to help determine the context-based options to provide via a user interface of the wireless network device 102 when a guest's presence is detected. Further, the user data 3469 may be associated with various sources of information corresponding to the user profile 346 of the user (e.g., occupant) and usable to determine possible contexts of the guest, such as a particular guest whose presence is anticipated within a particular block of time. For example, the user data 3469 may include, or be associated with, a digital calendar 3474, email messages 3476, short message service (SMS) messages 3478, a social media account 3480, and one or more applications 3482 (“apps”).

The calendar 3474 of the user may be accessible via the network 108 and may include the user's schedule (e.g., appointments, meetings, notifications, announcements, reminders). In aspects, the user's schedule may include information usable to predict a potential guest or guest type along with estimated reasons for their visit. For example, if the calendar 3474 indicates that the user is expecting a visit from an appliance repairman between 12:00 PM and 2:00 PM, then when a guest arrives during that period of time, the wireless network device 102 may provide one or more context-based options corresponding to the expected appliance repairman.

Messages, notifications, or other communications sent or received via the user's email messages 3476, SMS messages 3478, social media account 3480, and/or applications 3482 associated with the user data 3469 may be analyzed to detect whether the user is expecting a visit from a particular guest or type of guest.

Returning to FIG. 3B, the device profile 350-k corresponds to a device ‘k’ associated with a network environment 100 (e.g., HAN 202) such as a camera 136, a doorbell device 226, a client device 228, and the like. In some instances, the device profile 350-k includes device settings 3502, associated devices information 3504, associated user information 3506, associated event information 3508, and environmental data 3510. In some instances, the device profile 350-k includes only a subset of the above data. In some instances, the device profile 350-k includes additional device information not shown such as information regarding a current state of the device ‘k’.

The device settings 3502 include information regarding the current settings of device ‘k’ such as positioning information, mode of operation information, and the like. In some implementations and instances, the device settings 3502 are user-specific and are set by respective users of the device ‘k’. The associated devices information 3504 includes information regarding other devices associated with device ‘k’ such as other devices linked to device ‘k’ and/or other devices in the same network environment as device ‘k’. In some instances, the associated devices information 3504 includes a link, pointer, or reference to a respective device profile 350 of the associated device.

The associated user information 3506 includes information regarding users (also referred to herein as occupants of the structure 104) associated with the device such as users receiving notifications from the device, users registered with the device, users associated with the network environment of the device, and the like. In some instances, the associated user information 3506 includes a link, pointer, or reference to a user profile 346 corresponding to the associated user.

The associated event information 3508 includes information regarding events associated with the device ‘k’ such as historical events involving the device ‘k’ or captured by the device ‘k’. In some instances, the associated event information 3508 includes a link, pointer, or reference to an event record 354 corresponding to the associated event.

The environmental data 3510 includes information regarding the environment of device ‘k’ such as information regarding whether the device is outdoors or indoors, information regarding the light level of the environment, information regarding the amount of activity expected in the environment (e.g., information regarding whether the device is in a private residence versus a busy commercial property), information regarding environmental objects (e.g., depth mapping information for a camera), and the like.

The characterization data 360-s corresponds to an event ‘s’ detected within the network environment 100. As shown in FIG. 3B, in accordance with some implementations, the characterization data 360 includes an associated person identifier 3602, an associated image identifier 3604, quality information 3606, pose information 3608, timing information 3610, confidence information 3612, location information 3614, physical feature information 3616, and behavioral information 3618. In some implementations, the characterization data 360 includes additional data not shown, such as the smart devices or sensors that detected the event. In some implementations, the characterization data 360 includes only a subset of the data shown.

The associated person identifier 3602 includes a label or other identifier for each person represented by the characterization data. In some implementations, a label is applied by a user upon review of the corresponding image. In some implementations, the associated person identifier 3602 is assigned by the system in accordance with a determination that the characterization data 360 matches, or is similar to, other characterization data associated with the identifier.

The associated image identifier 3604 identifies one or more images from which the characterization data 360 was generated. In some implementations, there is a one-to-one mapping between the characterization data and the images, while in some other implementations, there is a many-to-one or one-to-many mapping. In some implementations, the associated image identifier 3604 includes a pointer or logical storage address for the one or more images.

The quality information 3606 includes a quality factor for the characterization data 360. In some implementations, the quality factor is based on one or more of: a blurriness of the image, a resolution of the image, an amount of the person that is visible in the image, how many features of the person are visible in the image, and a distance between the person and the camera that captured the image.

The pose information 3608 identifies a pose of each detected person. In some implementations, the pose information 3608 includes information regarding an angle between the camera that captured the image and the detected person. In some implementations, the pose information 3608 includes information regarding a portion of the person's face that is visible in the image.

The timing information 3610 includes information regarding when the image was captured by the camera. In some implementations, the timing information 3610 indicates the time of day, the day, the month, the year, etc. that the image was captured. In some implementations, the characterization data 360 includes operating information for the camera indicating the mode of operation and settings of the camera (e.g., indicating whether the camera was in a low-light mode when the image was captured). In some implementations, the timing information 3610 is used in conjunction with a device profile 350 for the camera to determine operating information for the camera at the time the image was captured.

The confidence information 3612 indicates a confidence that the associated person identifier(s) 3602 are accurate. In some implementations, the confidence information 3612 is based on a similarity between the characterization data 360 and other characterization data for the associated person(s). In some implementations, the confidence information 3612 includes a confidence score for the characterization data 360. In some implementations, in accordance with a determination that the confidence score is below a predetermined threshold, the association to the person(s) is reevaluated and/or the characterization data 360 and associated image is flagged as potentially having an incorrect associated person identifier 3602. In some implementations, flagged characterization data 360 is presented to a user for confirmation or reclassification.

The location information 3614 includes information regarding a location for the image and/or the detected person. In some implementations, the location information 3614 indicates a location for the camera that captured the image. In some implementations, the location information 3614 identifies the camera that captured the image. In some implementations, the location information 3614 indicates a room or portion of the network environment that was captured in the image. In some implementations, the location information 3614 indicates a global navigation satellite system (GNSS) (e.g., global positioning system (GPS)) or coordinates-based location for the image.

The physical feature information 3616 includes information regarding the physical features of the detected person(s). In some implementations, the physical feature information 3616 includes characterization of the person's physical features (e.g., nose, ears, eyes, and hair). In some implementations, the physical feature information 3616 includes information regarding the person's speech, gait, and/or posture. In some implementations, the physical feature information 3616 includes information regarding the person's dimensions, such as the distance between the person's eyes or ears, or the length of the person's arms or legs. In some implementations, the physical feature information 3616 includes information regarding the person's age, gender, and/or ethnicity. In some implementations, the physical feature information 3616 includes information regarding the person's clothing and/or accessories (e.g., whether the person is wearing a hat, glasses, gloves, and/or rings).

The behavioral information 3618 includes information regarding the behavior of the detected person. In some implementations, the behavioral information 3618 includes information regarding the detected person's mood and/or mannerisms.

Status data 362-o, illustrated in FIG. 3D, corresponds to a status ‘o’ relating to an electronic device (e.g., doorbell device 226) associated with the network environment 100. The status data 362-o includes information usable to determine an overall status or condition of, for example, a doorbell. As shown in FIG. 3D, in accordance with some implementations, the status data 362 includes a battery state of charge 3622, a battery state of health 3624, a battery temperature 3626, a battery heater status 3628, and one or more recorded software malfunction events 3630. The battery state of charge 3622 may include information relating to a current battery state of charge, a past battery state-of-charge value at a given time interval (e.g., a day, a week, a month), and/or one or more projected battery state-of-charge values (e.g., minutes, hours, days). The battery state of health 3624 may include information relating to a current battery state-of-health value, past battery state-of-health values (e.g., for an electronic device's lifetime), and/or a projected battery state of health. The battery temperature 3626 may include information relating to a current battery temperature, past battery temperatures (e.g., highs, lows, averages, trendlines), and/or projected battery temperatures based on, as non-limiting examples, a weather forecast. The battery heater status 3628 may include information relating to whether a battery heater is currently enabled or disabled and/or whether the battery heater was recently (e.g., within a predefined time frame) enabled or disabled. The software malfunction events 3630 may include information relating to logged software malfunctions. For example, in at least some hypothetical instances, while the battery heater is warming the battery of the electronic device, the electronic device may experience a software hang or crash. In such a scenario, non-physical mechanisms, including software, may be incapable of registering an internal temperature of the battery and turning off the battery heater. When the software of the electronic device regains control, the electronic device may register such an event as a software malfunction for it to be logged in the status data 362-o.

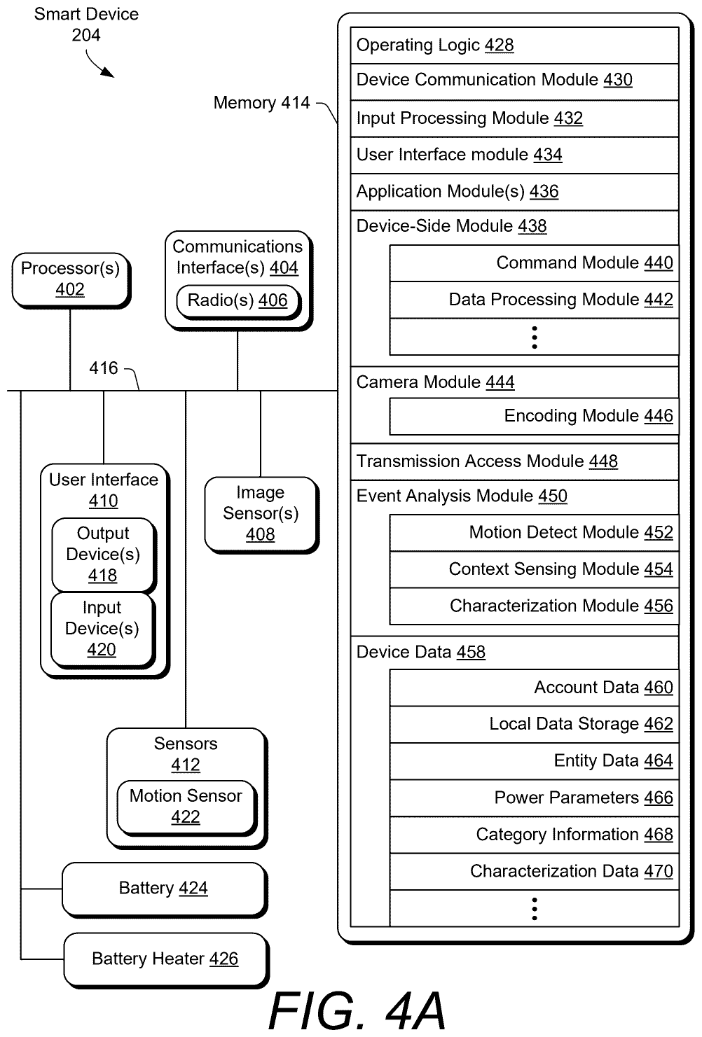

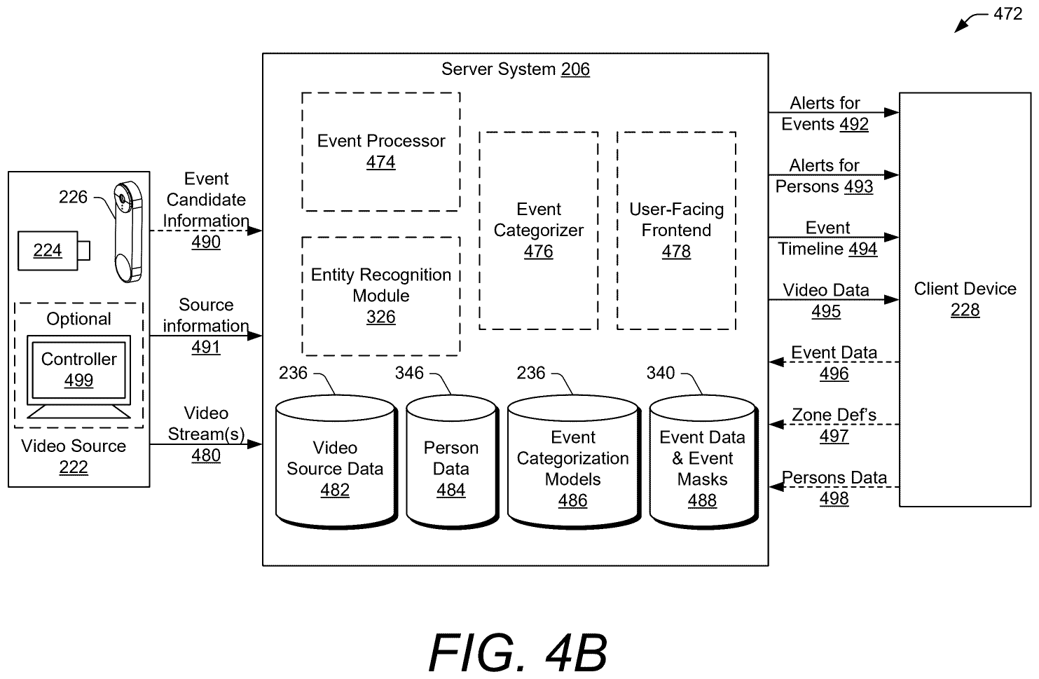

FIG. 4A is a block diagram illustrating a representative smart device 204 in accordance with some implementations. In some implementations, the smart device 204 (e.g., any device of the network environment 100 in FIG. 1) includes one or more processors 402 (e.g., CPUs, ASICs, FPGAs, microprocessors, and the like), one or more communication interfaces 404 with radios 406, image sensor(s) 408, user interface(s) 410, sensor(s) 412, memory 414, and one or more communication buses 416 for interconnecting these components (sometimes called a chipset). In some implementations, the user interface 410 includes one or more output devices 418 that enable presentation of media content, including one or more speakers and/or one or more visual displays. In some implementations, the user interface 410 includes one or more input devices 420, including user interface components that facilitate user input such as a keyboard, a mouse, a voice-command input unit or microphone, a touch screen display, a touch-sensitive input pad, a gesture capturing camera, or other input buttons or controls. In some implementations, an input device 420 for a doorbell device 226 is a tactile or touch-sensitive doorbell button. Furthermore, some smart devices 204 use a microphone and voice recognition or a camera and gesture recognition to supplement or replace the keyboard.

The sensor(s) 422 include, for example, one or more thermal radiation sensors, ambient temperature sensors, humidity sensors, infrared (IR) sensors such as passive infrared (PIR) sensors, proximity sensors, range sensors, occupancy sensors (e.g., using radio frequency identification (RFID) sensors), ambient light sensors (ALS), motion sensors 422, location sensors (e.g., GPS sensors), accelerometers, and/or gyroscopes.

In some implementations, the smart device 204 includes a battery 424 (e.g., one or more battery packs and/or capacitors). In some implementations, the battery 424 includes a power management integrated circuit (IC). In some implementations, the battery 424 includes circuitry to harvest energy from signals received via an antenna (e.g., the radios 406) of the smart device. In some implementations, the battery 424 includes circuitry to harvest thermal, vibrational, electromagnetic, and/or solar energy received by the smart device. In some implementations, the battery 424 includes circuitry to monitor a stored energy level and adjust operation and/or generate notifications based on changes to the stored energy level.

In implementations, the smart device 204 further includes a battery heater 426. The battery heater 426 may be configured to, upon activation by one or more processors 402, generate heat via electrical means so as to warm the battery 424 and/or subsystems in proximity to the battery 424. For example, one or more processors 402 may register an internal and/or external temperature (e.g., a temperature surrounding the battery 424, an internal temperature of the battery 424, an ambient temperature surrounding the smart device 204) using sensors 412, such as a thermistor, resistance temperature detectors (RTDs), thermocouples, and/or semiconductor-based sensors. Using the registered temperature, the processor(s) 402 may determine that the temperature is below a first threshold and activate the battery heater 426. When the internal and/or external temperature exceeds a second threshold that is higher than the first threshold, then the one or more processors 402 may deactivate the battery heater 426.

The communication interfaces 404 include, for example, hardware capable of data communications using any of a variety of custom or standard wireless protocols (e.g., IEEE 802.15.4, Wi-Fi, ZigBee, 6LoWPAN, Thread, Z-Wave, Bluetooth Smart, ISA100.5A, WirelessHART, MiWi, etc.) and/or any of a variety of custom or standard wired protocols (e.g., Ethernet, HomePlug, etc.), or any other suitable communication protocol, including communication protocols not yet developed as of the filing date of this document. The radios 406 enable one or more radio communication networks in the network environments 100 and enable a smart device 204 to communicate with other devices. In some implementations, the radios 406 are capable of data communications using any of a variety of custom or standard wireless protocols (e.g., IEEE 802.15.4, Wi-Fi, ZigBee, 6LoWPAN, Thread, Z-Wave, Bluetooth Smart, ISA100.5A, WirelessHART, MiWi, etc.).

The memory 414 includes high-speed random access memory (e.g., DRAM, SRAM, DDR RAM, or other random access solid-state memory devices) and, optionally, includes non-volatile memory (e.g., one or more magnetic disk storage devices, one or more optical disk storage devices, one or more flash memory devices, or one or more other non-volatile solid-state storage devices). The memory 414, or alternatively the non-volatile memory within the memory 414, includes a non-transitory computer-readable storage medium. In some implementations, the memory 414, or the non-transitory computer-readable storage medium of the memory 414, stores the following programs, modules, and data structures, or a subset or superset thereof:
operating logic 428 including procedures for handling various basic system services and for performing hardware-dependent tasks,
a communication module 430 for coupling to and communicating with other network devices (e.g., a network interface 208, such as a router that provides Internet connectivity, networked storage devices, network routing devices, a server system 206, other smart devices 204, client devices 228, etc.) connected to one or more networks 108 via one or more communication interfaces 404 (wired or wireless);
an input processing module 432 for detecting one or more user inputs or interactions from the one or more input devices 420 and interpreting the detected inputs or interactions;
a user interface module 434 for providing and presenting a user interface in which settings, captured data, and/or other data for one or more devices (e.g., the smart device 204, and/or other devices in a network environment 100) can be configured and/or viewed;
one or more applications 436 for execution by the smart device (e.g., games, social network applications, smart home applications, and/or other web or non-web based applications) for controlling devices (e.g., executing commands, sending commands, and/or configuring settings of the smart device 204 and/or other client/electronic devices), and for reviewing data captured by devices (e.g., device status and settings, captured data, or other information regarding the smart device 204 and/or other client/electronic devices);
a device-side module 438, which provides device-side functionalities for device control, data processing and data review, including but not limited to:
   a command module 440 for receiving, forwarding, and/or executing instructions and control commands (e.g., from a client device 228, from a server system 206, from user inputs detected on the user interface 410, etc.) for operating the smart device 204; and
   a data processing module 320 for processing data captured or received by one or more inputs (e.g., input devices 420, image sensor(s) 408, sensors 412), interfaces (e.g., communication interfaces 404, radios 406), and/or other components of the smart device 204, and for preparing and sending processed data to a remote device (e.g., client devices 228) for review by a user;
a camera module 444 for operating the image sensor(s) 408 and associated circuitry, e.g., for enabling and disabling the image sensor(s) 408 based on data from one or more low-power sensors 412 (e.g., data from a PIR sensor or ALS), including an encoding module 446 for adjusting encoding of raw image data captured by the image sensor(s) 408 (e.g., adjusting format, resolution, and/or framerate);
a transmission access module 448 for granting or denying transmission access to one or more radio(s) 406 (e.g., based on detected control signals and transmission requests);
an event analysis module 450 for analyzing captured sensor data, e.g., to detect and/or recognize approaching visitors and context information, including but not limited to:
   a motion detect module 452 for detecting events in the network environment (e.g., motion events in the video data), such as an approaching guest; and
   a context sensing module 454 for detecting context data regarding an approaching guest, e.g., based on behavioral characteristics, object recognition, facial recognition, voice recognition, timing information, and user data associated with a user profile of the user (e.g., occupant);
   a characterization module 456 for characterizing entities, persons (e.g., the approaching guest), and/or events detected by, or associated with, the smart device 204;
device data 458 storing data associated with devices (e.g., the smart device 204), including, but not limited to:
   account data 460 storing information related to user accounts linked to the smart device 204, e.g., including cached login credentials, smart device identifiers (e.g., MAC addresses and UUIDs), user interface settings, display preferences, authentication tokens and tags, password keys, and the like;
   local data storage 462 for selectively storing raw or processed data associated with the smart device 204, such as event data and/or video data captured by the image sensor(s) 408;
   entity data 464 storing information related to detected persons and other entities, such as characterization information (e.g., characterization data 470) and associated images;
   power parameters 466 storing energy information, such as information related to the battery 424 (e.g., estimated battery life), power settings of the smart device 204, a power state of the smart device 204, power preferences of user(s) of the smart device 204, and the like;
   category information 468 detailing event categories for categorizing events detected by, or involving, the smart device (e.g., in conjunction with the event analysis module 450); and
   characterization data 470 for entities, persons, and/or events detected by, or associated with, the smart device 204 (e.g., data generated or used by the characterization module 456).

Each of the above-identified elements may be stored in one or more of the previously mentioned memory devices and corresponds to a set of instructions for performing a function described above. The above-identified modules or programs (e.g., sets of instructions) need not be implemented as separate software programs, procedures, or modules, and thus various subsets of these modules may be combined or otherwise rearranged in various implementations. In some implementations, the memory 414, optionally, stores a subset of the modules and data structures identified above. Furthermore, the memory 414, optionally, stores additional modules and data structures not described above, such as a sensor management module for managing operation of the sensor(s) 412.

FIG. 4B illustrates a representative system architecture 472 including video source(s) 222, server system 206, and client device(s) 228 in accordance with some implementations. In some implementations, the server system 206 includes functional modules for an event processor 474, an event categorizer 476, an entity recognition module 326, and a user-facing frontend 478 (e.g., server-side module 314). The event processor 474 obtains the event candidates (e.g., by processing video stream(s) 480, by receiving event start information from the video source 222, or by detecting a user press on a doorbell button of a video-capturing doorbell device 226). In some implementations, the event candidates comprise motion event candidates. In some implementations, the event candidates comprise audio event candidates. In some implementations, the event candidates include a user press on the doorbell button of the video-capturing doorbell device 226. In some implementations, the event candidates include audio, electromagnetic, olfactory, and/or visual aspects. In some implementations, the event candidates include motion events, approach detections, and announcement detections. The event categorizer 476 categorizes the event candidates into different event categories (e.g., based on data from the event processor and/or the entity recognizer). The user-facing frontend 478 generates event alerts and notifications and facilitates review of the detected entities and events by a reviewer through a review interface on a client device 228. The user-facing frontend 478 also receives user edits on the event and entity categories, user preferences for alerts and event filters, zone definitions for zones of interest, and the like. The event categorizer 476 optionally revises event categorization models and results based on the user edits received by the user-facing frontend 478. The entity recognition module 326 optionally revises entity classifications and/or labels based on the user edits received by the user-facing frontend 478. The server system 206 also includes databases for storing video source data 482, person data 484, event categorization models 486, and event data and event masks 488. In implementations, the person data 484 is stored in a person database (e.g., the persons database 358). In some implementations, each of these databases is part of the server database 340 (e.g., part of data storage database 342).

The server system 206 receives one or more video stream(s) 480 from the video source 222 and optionally receives event candidate information 490, such as preliminary characterization information for detected entities and events (e.g., entity and event metadata from processing performed at the doorbell device 226), and source information 491 such as device settings for a doorbell device 226 (e.g., a device profile 350 for doorbell device 226). In some implementations, the event processor 474 communicates with the video source 222 and/or one or more other devices of the network environment, e.g., to request additional image data, audio data, and sensor data, such as high-definition images or metadata for the video stream(s) 480. The server system sends alerts for events 492, alerts for detected persons 493, event timeline information 494, and/or video data 495 (e.g., still images or video clips corresponding to the detected persons and/or events) to the client device 228. In some implementations, the alerts distinguish guest approach events from other types of motion events. In some implementations, the alerts distinguish motion events captured at a doorbell device 226 from motion events captured by other smart devices (e.g., cameras 136). The server system 206 optionally receives user information from the client device 228, such as event data 496 (e.g., edits to event categories), zone definitions 497, and persons data 498 (e.g., classification of detected persons).

A data processing pipeline processes video information (e.g., a live video feed) received from a video source 222 (e.g., including a doorbell device 226 and an optional controller device 499) and/or audio information received from one or more smart devices in real-time (e.g., within 10 seconds, 30 seconds, or 2 minutes) to identify and categorize events occurring in the network environment, and sends real-time event alerts (e.g., within 10 seconds, 20 seconds, or 30 seconds) and/or a refreshed event timeline (e.g., within 30 seconds, 1 minute, or 3 minutes) to a client device 228 associated with a reviewer account for the network environment. The data processing pipeline also processes stored information (such as stored video feeds from a video source 222) to reevaluate and/or re-categorize events as necessary, such as when new information is obtained regarding the event and/or when new information is obtained regarding event categories (e.g., a new activity zone definition is obtained from the user).

After video and/or audio data is captured at a smart device, the data is processed to determine if any potential event candidates or persons are present. In some implementations, the data is initially processed at the smart device (e.g., video source 222, camera 136, or doorbell device 226). Thus, in some implementations, the smart device sends event candidate information 490, such as event start information, to the server system 206. In some implementations, the data is processed at the server system 206 for event start detection. In some implementations, the video and/or audio data is stored at server system 206 (e.g., in the video storage database 236). In some implementations, the visual/audio data is stored at a server distinct from the server system 206. In some implementations, after a motion start is detected, the relevant portion of the video stream is retrieved from storage (e.g., from the video storage database 236).

In some implementations, the event identification process includes segmenting the video stream into multiple segments and then categorizing the event candidate within each segment. In some implementations, categorizing the event candidate includes an aggregation of background factors, entity detection and identification, motion vector generation for each motion entity, entity features, and scene features to generate motion features for the event candidate. In some implementations, the event identification process further includes categorizing each segment, generating or updating an event log based on categorization of a segment, generating an alert for the event based on categorization of a segment, categorizing the complete event, updating the event log based on the complete event, and generating an alert for the event based on the complete event. In some implementations, a categorization is based on a determination that the event occurred within a particular zone of interest. In some implementations, a categorization is based on a determination that the event candidate involves one or more zones of interest. In some implementations, a categorization is based on audio data and/or audio event characterization.

The event analysis and categorization process may be performed by the smart device (e.g., the video source 222) and the server system 206 cooperatively, and the division of the tasks may vary in different implementations, for different equipment capability configurations, power parameters, and/or for different network, device, and server load situations. After the server system 206 categorizes the event candidate, the result of the event detection and categorization may be sent to a reviewer associated with the network environment.

In some implementations, the server system 206 stores raw or compressed video source data 482 (e.g., in the video storage database 236), event categorization models 486 (e.g., in the categorization model database 356), and event masks and other event metadata (e.g., in the event information database 352) for each of the video sources 222. In some implementations, the video data is stored at one or more display resolutions such as 482p, 780p, 1080i, 1080p, and the like.

In some implementations, the video source 222 (e.g., the doorbell device 226) transmits a live video feed to the remote server system 206 via one or more networks (e.g., the network(s) 108). In some implementations, the transmission of the video data is continuous as the video data is captured by the doorbell device 226. In some implementations, the transmission of video data is irrespective of the content of the video data, and the video data is uploaded from the video source 222 to the server system 206 for storage irrespective of whether any motion event has been captured in the video data. In some implementations, the video data is stored at a local storage device of the video source 222 by default, and only video portions corresponding to motion event candidates detected in the video stream are uploaded to the server system 206 (e.g., in real-time or as requested by a user).

In some implementations, the video source 222 dynamically determines at what display resolution the video stream is to be uploaded to the server system 206. In some implementations, the video source 222 dynamically determines which parts of the video stream are to be uploaded to the server system 206. For example, in some implementations, depending on the current server load and network conditions, the video source 222 optionally prioritizes the uploading of video portions corresponding to newly detected motion event candidates ahead of other portions of the video stream that do not contain any motion event candidates; or the video source 222 uploads the video portions corresponding to newly detected motion event candidates at higher display resolutions than the other portions of the video stream. This upload prioritization helps to ensure that motion events of interest are detected and alerted to the reviewer in real-time, even when the network conditions and server load are less than optimal. In some implementations, the video source 222 implements two parallel upload connections, one for uploading the continuous video stream captured by the doorbell device 226, and the other for uploading video portions corresponding to detected motion event candidates. At any given time, the video source 222 determines whether the uploading of the continuous video stream needs to be suspended temporarily to ensure that sufficient bandwidth is given to the uploading of the video segments corresponding to newly detected motion event candidates.

In some implementations, the video stream uploaded for cloud storage is of a lower quality (e.g., lower resolution, lower frame rate, higher compression, etc.) than the video segments uploaded for motion event processing.

As shown in FIG. 4B, the video source 222 optionally includes a video doorbell device 226 and an optional controller device 499. In some implementations, the doorbell device 226 includes sufficient on-board processing power to perform all necessary local video processing tasks (e.g., cuepoint detection for motion event candidates, video uploading prioritization, network connection management, etc.), and the doorbell device 226 communicates with the server system 206 directly, without any controller device 499 acting as an intermediary. In some implementations, the doorbell device 226 captures the video data and sends the video data to the controller device 499 for the necessary local video processing tasks. The controller device 499 optionally performs the local processing tasks for multiple cameras. For example, there may be multiple cameras in one network environment (e.g., the network environment 100, FIG. 1), and a single controller device 499 receives the video data from each camera and processes the video data to detect motion event candidates in the video stream from each camera. The controller device 499 is responsible for allocating sufficient outgoing network bandwidth to transmit video segments containing motion event candidates from each camera to the server before using the remaining bandwidth to transmit the video stream from each camera to the server system 206. In some implementations, the continuous video stream is sent and stored at one server facility while the video segments containing motion event candidates are sent to and processed at a different server facility.

In some implementations, the smart device sends additional source information 491 to the server system 206. This additional source information 491 may include information regarding a device state (e.g., IR mode, auto exposure (AE) mode) and/or information regarding the environment in which the device is located (e.g., indoors, outdoors, night-time, day-time, etc.). In some implementations, the source information 491 is used by the server system 206 to perform event detection, entity recognition, and/or categorize event candidates. In some implementations, the additional source information 491 includes one or more preliminary results from video processing performed by the video source 222 (e.g., a doorbell device 226), such as categorizations, object/entity recognitions, motion masks, and the like.

In some implementations, the video portion after an event start incident is detected is divided into multiple segments. In some implementations, the segmentation continues until event end information (sometimes also called an “end-of-event signal”) is obtained. In some implementations, the segmentation occurs within the server system 206 (e.g., by the event processor 474). In some implementations, the segmentation comprises generating overlapping segments. For example, a 10-second segment is generated every second, such that a new segment overlaps the prior segment by 9 seconds.

In some implementations, each of the multiple segments is of the same or similar duration (e.g., each segment has a 10-12 second duration). In some implementations, the first segment has a shorter duration than the subsequent segments. Keeping the first segment short allows for real-time initial categorization and alerts based on processing the first segment. The initial categorization may then be revised based on processing of subsequent segments. In some implementations, a new segment is generated if the motion entity enters a new zone of interest.

In some implementations, after the event processor module obtains the video portion corresponding to an event candidate, the event processor 474 obtains background factors and performs motion entity detection identification, motion vector generation for each motion entity, and feature identification. Once the event processor 474 completes these tasks, the event categorizer 476 aggregates all of the information and generates a categorization for the motion event candidate. In some implementations, the event processor 474 and the event categorizer 476 are components of the video processing module 322. In some implementations, false positive suppression is optionally performed to reject some motion event candidates before the motion event candidates are submitted for event categorization. In some implementations, determining whether a motion event candidate is a false positive includes determining whether the motion event candidate occurred in a particular zone. In some implementations, determining whether a motion event candidate is a false positive includes analyzing an importance score for the motion event candidate. The importance score for a motion event candidate is optionally based on zones of interest involved with the motion event candidate, background features, motion vectors, scene features, entity features, motion features, motion tracks, and the like.

In some implementations, the video source 222 has sufficient processing capabilities to perform, and does perform, entity detection, person recognition, background estimation, motion entity identification, the motion vector generation, and/or the feature identification.

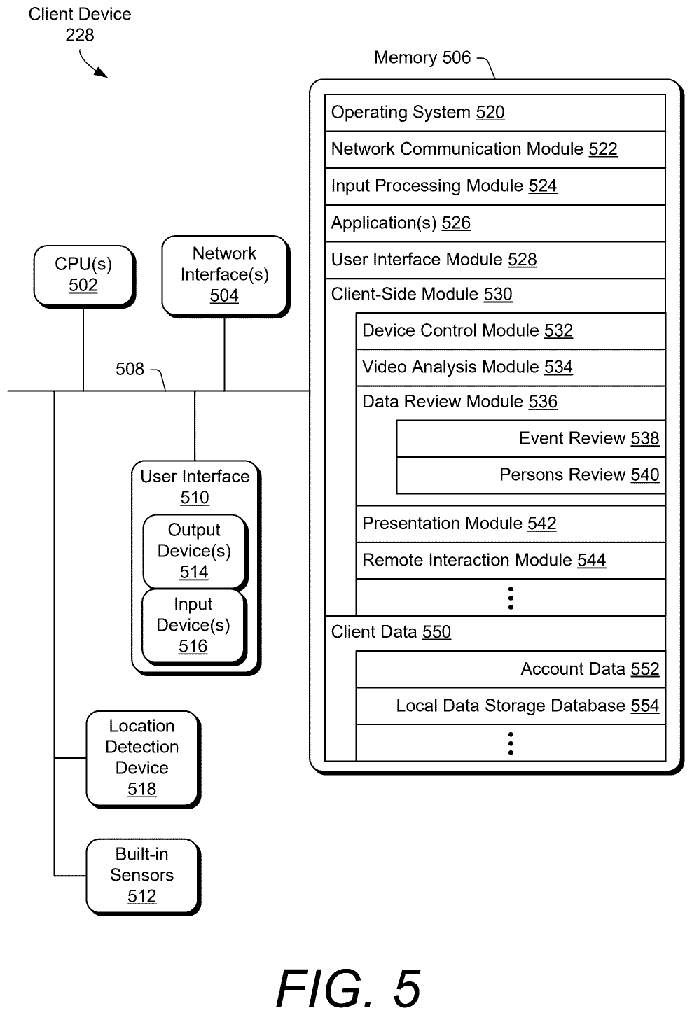

FIG. 5 is a block diagram illustrating a representative client device 228 associated with a user account in accordance with some implementations. The client device 228, typically, includes one or more processing units (CPUs) 502, one or more network interfaces 504, memory 506, and one or more communication buses 508 for interconnecting these components (sometimes called a chipset). Optionally, the client device also includes a user interface 510 and one or more built-in sensors 512 (e.g., accelerometer and gyroscope). The user interface 510 includes one or more output devices 514 that enable presentation of media content, including one or more speakers and/or one or more visual displays. The user interface 510 also includes one or more input devices 516, including user interface components that facilitate user input such as a keyboard, a mouse, a voice-command input unit or microphone, a touch screen display, a touch-sensitive input pad, a gesture capturing camera, or other input buttons or controls. Furthermore, some the client devices use a microphone and voice recognition or a camera and gesture recognition to supplement or replace the keyboard. In some implementations, the client device includes one or more cameras, scanners, or photo sensor units for capturing images (not shown). Optionally, the client device includes a location detection device 518, such as a GPS sensor or other geo-location receiver, for determining the location of the client device.

The memory 506 includes high-speed random access memory, such as DRAM, SRAM, DDR SRAM, or other random access solid-state memory devices; and, optionally, includes non-volatile memory, such as one or more magnetic disk storage devices, one or more optical disk storage devices, one or more flash memory devices, or one or more other non-volatile solid-state storage devices. The memory 506, optionally, includes one or more storage devices remotely located from one or more processing units 502. The memory 506, or alternatively the non-volatile memory within the memory 506, includes a non-transitory computer-readable storage medium. In some implementations, the memory 506, or the non-transitory computer-readable storage medium of the memory 506, stores the following programs, modules, and data structures, or a subset or superset thereof:
an operating system 520 including procedures for handling various basic system services and for performing hardware-dependent tasks;
a network communication module 522 for connecting the client device 228 to other systems and devices (e.g., client devices, electronic devices, and systems connected to one or more networks 108) via one or more network interfaces 504 (wired or wireless);
an input processing module 524 for detecting one or more user inputs or interactions from one of the one or more input devices 516 and interpreting the detected input or interaction;
one or more applications 526 for execution by the client device (e.g., games, social network applications, smart home applications, and/or other web or non-web based applications) for controlling devices (e.g., sending commands, configuring settings, etc. to hub devices and/or other client or electronic devices) and for reviewing data captured by the devices (e.g., device status and settings, captured data, or other information regarding the hub device or other connected devices);
a user interface module 528 for providing and displaying a user interface in which settings, captured data, and/or other data for one or more devices (e.g., smart devices 204 in network environment 100) can be configured and/or viewed;
a client-side module 530, which provides client-side functionalities for device control, data processing and data review, including but not limited to:
   a device control module 532 for generating control commands for modifying an operating mode of smart devices (and optionally other electronic devices) in accordance with user inputs;
   a video analysis module 534 for analyzing captured video data, e.g., to detect and/or recognize persons, objects, animals, and events;
   a data review module 536 for providing user interfaces for reviewing data from the server system 206 or video sources 222, including but not limited to:
      an event review module 538 for reviewing events (e.g., motion and/or audio events), and optionally enabling user edits and/or updates to the events; and
      a person's review module 540 for reviewing data and/or images regarding detected persons and other entities, and optionally enabling user edits and/or updates to the persons data;
   a presentation module 542 for presenting user interfaces and response options for interacting with the smart devices 204 and/or the server system 206; and
   a remote interaction module 544 for interacting with a remote person (e.g., a visitor to the network environment 100), e.g., via a smart device 204 and/or the server system 206; and
client data 546 storing data associated with the user account and electronic devices, including, but not limited to:
   account data 548 storing information related to both user accounts loaded on the client device and electronic devices (e.g., of the video sources 222) associated with the user accounts, wherein such information includes cached login credentials, hub device identifiers (e.g., MAC addresses and UUIDs), electronic device identifiers (e.g., MAC addresses and UUIDs), user interface settings, display preferences, authentication tokens and tags, password keys, etc.; and
   a local data storage database 550 for selectively storing raw or processed data associated with electronic devices (e.g., of the video sources 222, such as a doorbell 226), optionally including entity data described previously.

Each of the above-identified elements may be stored in one or more of the previously mentioned memory devices and may correspond to a set of instructions for performing a function described above. The above-identified modules or programs (e.g., sets of instructions) need not be implemented as separate software programs, procedures, modules, or data structures, and thus various subsets of these modules may be combined or otherwise rearranged in various implementations. In some implementations, the memory 506, optionally, stores a subset of the modules and data structures identified above. Furthermore, the memory 506, optionally, stores additional modules and data structures not described above.

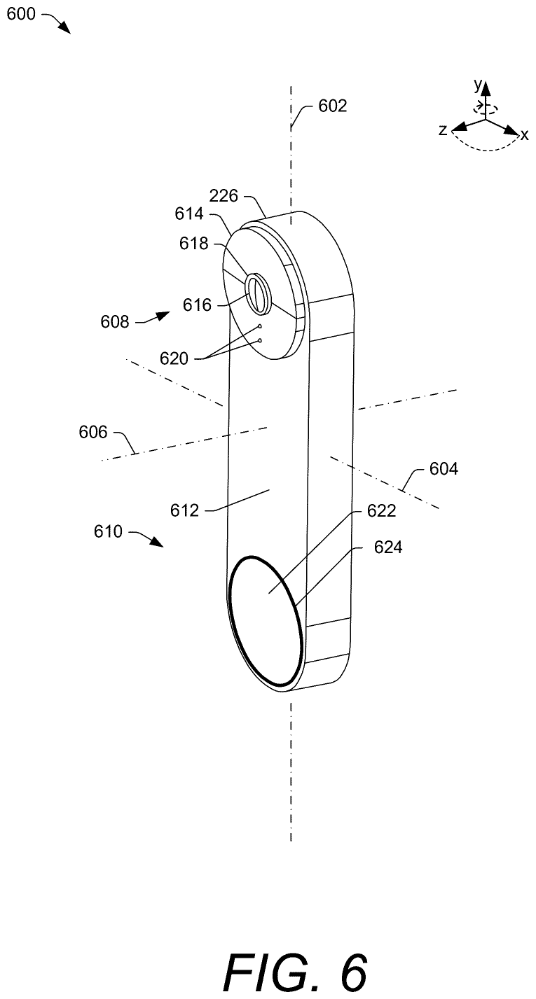

FIG. 6 illustrates an isometric view 600 of an example video-capturing doorbell (e.g., doorbell 226), in accordance with some implementations. The doorbell 226 is illustrated as having a longitudinal axis 602 (e.g., y-axis), a lateral axis 604 (e.g., x-axis), and a central axis 606 (e.g., z-axis). The doorbell 226 may be elongated along the longitudinal axis such that the doorbell 226 has a height along the longitudinal axis 602 that is significantly greater (at least by a magnitude of two) than a width along the lateral axis 604, and the width is greater than a depth along the central axis 606 (at least by a factor of 1.5). The doorbell 226 includes a camera-side end 608 and a button-side end 610, which are at opposing ends of a first surface (e.g., front surface 612) of the housing. The camera-side end 608 of the doorbell 226 includes an IR cover 614, which includes a portion that is substantially transparent (e.g., 70%, 80%, 90%, 100% transparent) or translucent (e.g., between 31% and 69% transparent) to IR light and another portion that is substantially opaque (e.g., 70%, 80%, 90%, 100% opaque) to IR light.

In aspects, the IR cover extends outwardly from a front surface 612 (e.g., front surface) of the housing of the doorbell 226. The IR cover 614 forms an annular shape with a center aperture through which a camera lens 616 of the camera module (e.g., camera module 444 in FIG. 4A) extends. The annular shape is generally elliptical and, in some cases, where its major and minor axes are equal, the shape may be circular. A retainer 618 (e.g., lens retainer) surrounds the camera lens 616 in the xy plane and extends through the center aperture of the IR cover 614 to protrude from an outer surface of the IR cover 614. In an example, the retainer 618 has a substantially tubular shape (with an elliptical cross-section, such as a circular cross-section) and the camera lens 616 is positioned within a center area of the retainer 618. Both the retainer 618 and the camera lens 616 extend outwardly from the front surface 612 of the housing, including extending outwardly from the outer surface of the IR cover 614. In some implementations, the camera lens 616 protrudes slightly (along the z-axis) from the end of the retainer 618. The retainer 618 reduces and/or prevents IR light from leaking into the camera lens 616 through the IR cover 614. The IR light may be provided by IR illuminators (e.g., IR LEDs) disposed behind the IR cover 614 and configured to direct the IR light through one or more apertures 620 in the IR cover 614. Also, the IR light may be received from the ambient environment, through the IR cover, and captured by a sensor (e.g., the image sensor, a passive infrared (PIR) sensor). Accordingly, the retainer 618 prevents the IR light from leaking into the sides or edges of the camera lens 616 from the IR cover 614.

The button-side end 610 of the doorbell 226 includes a button 622, which is pressable by a user to initiate a notification (e.g., chime). In aspects, the button 622 may be surrounded by a light ring 624, which may be substantially flush with the front surface 612 of the doorbell 226. The button 622 and/or light ring 624 may have a shape and/or size that substantially matches the outline and/or size of the IR cover 614. In an example, the button 622 may have a diameter that is substantially equal to the outer diameter of the IR cover 614. In another example, the light ring 624 has an outer diameter that is substantially the same as the outer diameter of the IR cover 614.

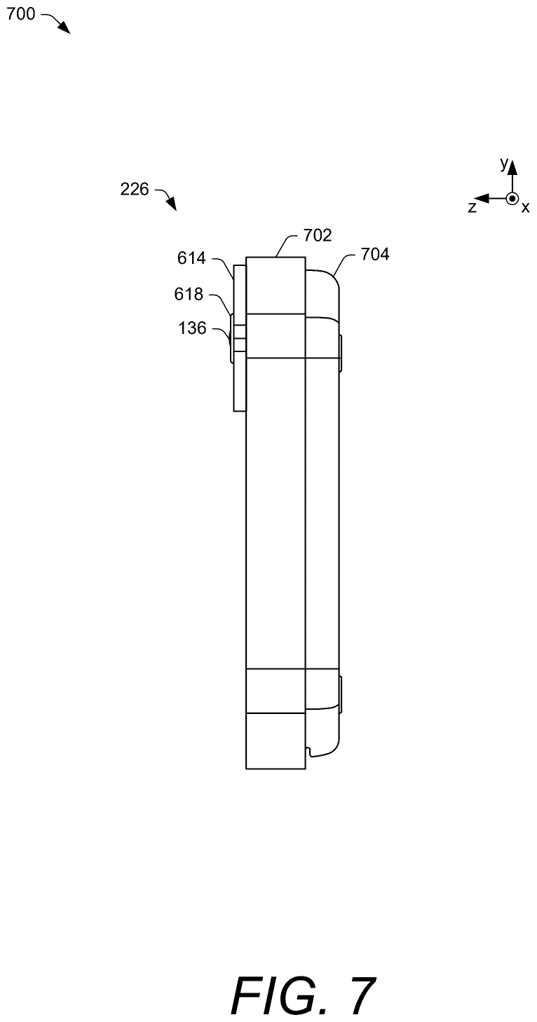

FIG. 7 illustrates a right elevational view 700 of the example doorbell 226 in FIG. 6, in accordance with some implementations. As illustrated, the retainer 618 extends outwardly (in the z-direction) from the IR cover 614, which prevents IR light traveling through the IR cover 614 from leaking into the camera lens 616. The camera lens 616 may extend outwardly (in the z-direction) from the retainer 618 in order to maximize the field of view of the image sensor (e.g., image sensor 408 in FIG. 4A) via the camera lens 616. In aspects, the doorbell 226 includes a housing, which is formed by a front housing component 702 affixed to a rear housing component 704.

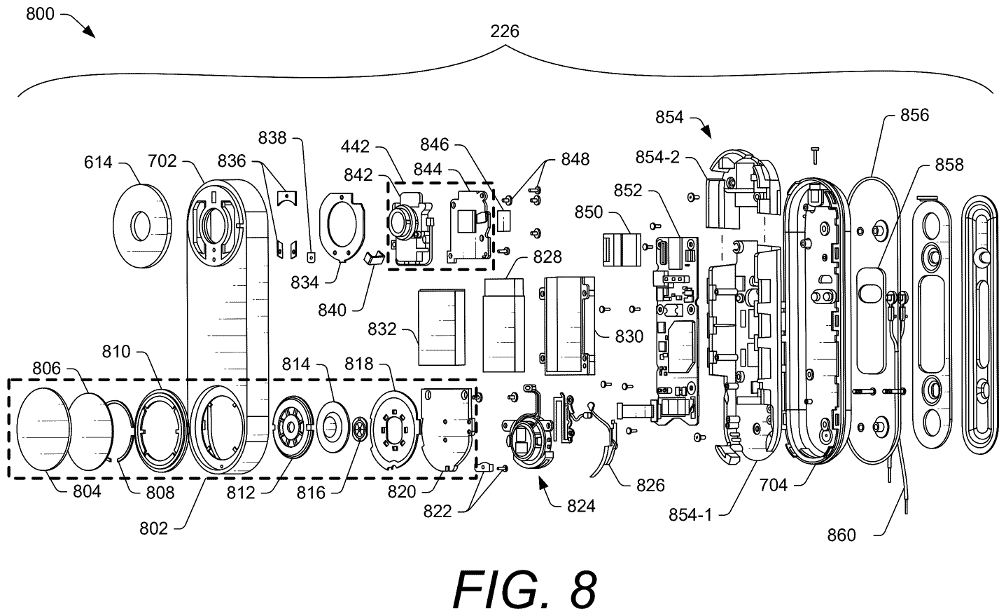

FIG. 8 illustrates an exploded view 800 of the example doorbell 226 in FIG. 6. The front housing component 702 and the rear housing component 704 connect together to form a housing that encloses various components of the doorbell 226. The IR cover 614 is assembled to an exterior surface (e.g., front surface, the front surface 612 in FIG. 6) of the front housing component 702.

At the button-side end 610 the doorbell 226 includes a button subassembly 802 (also referred to as the button 622), which is part light ring for animations to show when the button subassembly 802 is being pressed. Additionally, the button subassembly 802 is waterproof sealed to prevent water ingress into the interior of the device through or around the button subassembly 802. The button subassembly 802 may include a button cap 804, a first reflector 806, button foam 808, a button flange 810, a light guide 812, an elastic button 814, a dome 816, a second reflector 818, and a button PCB (e.g., button board 820). One or more fasteners (e.g., fasteners 822) may be used to assemble the components of the button subassembly 802 together. Pressing the button cap 804 on the button subassembly 802 completes an electrical circuit on the button board 820, which enables detection of a presence of a person.

The doorbell 226 also includes a speaker subassembly 824 and one or more antennas 826, which are assembled in proximity to one another and to the button subassembly 802. The doorbell 226 includes a battery 828, which may be seated into a battery frame 830. A thermal management subassembly 832 may fully or partially envelop the battery 828. The thermal management subassembly 832 may be configured to evenly distribute heat to the battery 828, providing cooling (e.g., via heat spreading) or heating (e.g., via heat generation), and maintain a temperature gradient of the battery 828 within a desired level. The thermal management subassembly may operate differently when the doorbell 226 is exposed to various temperatures. For example, when the doorbell 226 is subject to a cold environment (e.g., sub-zero Celsius temperatures), the thermal management subassembly 832 may heat the battery 828. The battery 828 and the thermal management subassembly 832 both include separate physical and electrical connections to a main logic board.

At the camera-side end 608, the doorbell 226 may include a PCB 834, which may be a subassembly for IR sensors (passive infrared sensors), IR LEDs, and/or audio sensors (e.g., microphone). Pressure-sensitive adhesive (PSA) 836 may be disposed between the PCB 834 and the front housing component 702. Also, mesh 838 for the audio sensor may be disposed adjacent to the audio sensor. Additionally, an IR flexible printed circuit (FPC) 840 may connect the PCB 834 to the camera module 442. The camera module 442 includes a camera subassembly 842 and a PCB (e.g., camera board 844). The camera subassembly 842 is aligned with the IR cover 614. In aspects, one or more thermal interface materials (TIMs) 846 may be disposed adjacent to the camera board 844 to transfer heat generated by one or more integrated circuit components on the camera board 844, including an image sensor. Fasteners 848 may be used to fasten the camera board 844 to the camera subassembly 842 and/or the front housing component.

A main FPC 850 may be used to connect the camera board 844 to a main logic board (MLB) subassembly 852 for the doorbell 226. The MLB subassembly 852 is positioned toward the back of the product assembly to avoid coupling heat generated by the MLB subassembly 852 with a heat load from external sources (e.g., solar load from the sun). The heat sink 854 is disposed adjacent to the MLB subassembly 852 and the camera board 844 to passively distribute heat away from the MLB subassembly 852 and the camera board 844 and transfer the heat toward the housing, including the rear housing component 704. In addition, the heat sink 854 is used as a ground plane for a plurality of the electrical components within the doorbell 226.

The heat sink 854 includes multiple sections (e.g., a first section 854-1, a second section 854-2). The first section 854-1 and the second section 854-2 both nest into the rear housing component 704. In aspects, the first section 854-1 is disposed adjacent to the MLB subassembly 852 and is configured to absorb and distribute heat from the MLB subassembly 852. The first section 854-1 transfers the heat generated by the MLB subassembly 852 to a lower portion of the housing, including the button-side end 610. The first section 854-1 is also coupled to the speaker subassembly 824 and the antennas 826 to electrically ground the speaker subassembly 824 and the antennas 826. The second section 854-2 is disposed adjacent to the camera subassembly 842 and is configured to absorb and distribute heat from the camera subassembly 842. Accordingly, the heat sink 854 enables the amount of heat sink necessary for the camera subassembly 842 to be separate from the amount of heat sink necessary for the MLB subassembly 852. Dividing the heat sink 854 into separate sections for the different heat-generating subassemblies provides a significant reduction in temperature, thereby enhancing passive thermal control, over conventional doorbell devices that use a single heat sink for both the MLB and the camera sensor.

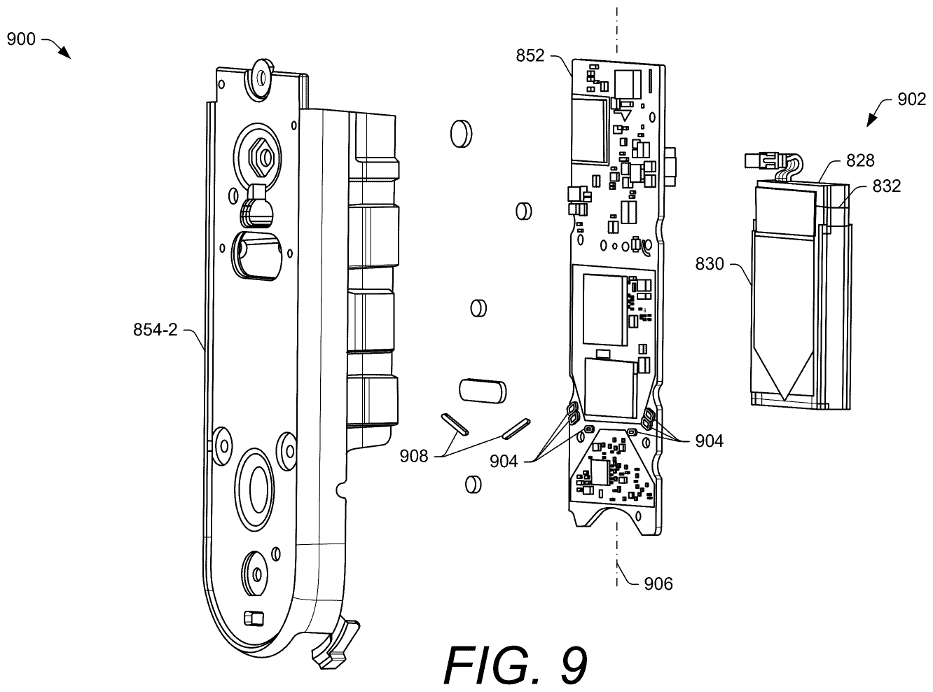

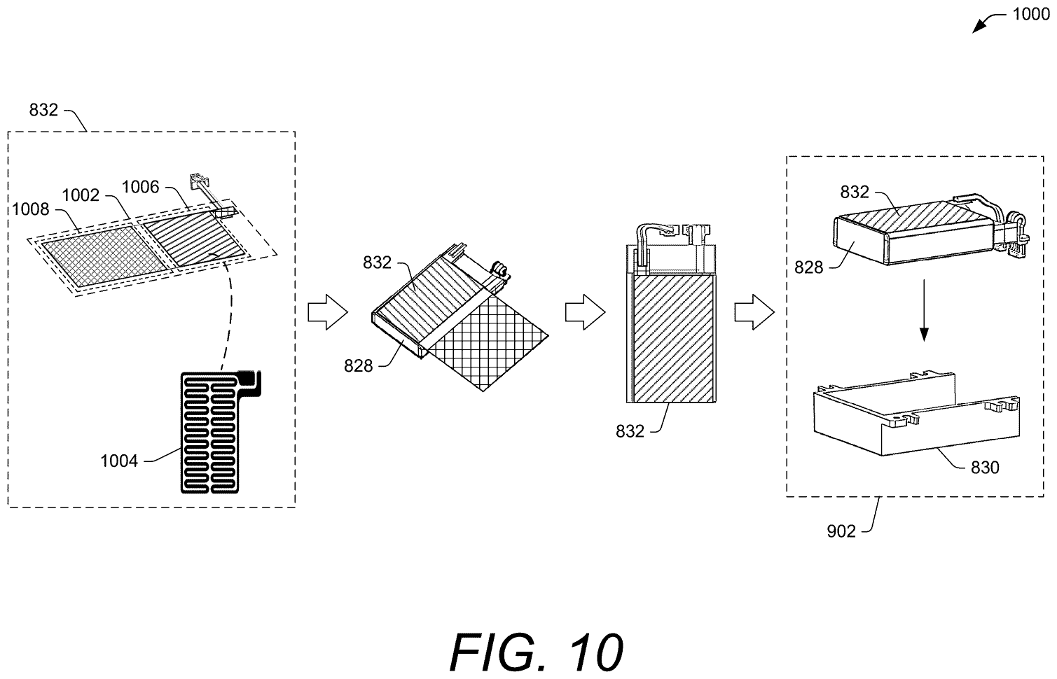

In some implementations, the two parts of the heat sink 854 form a substantially obround shape (in the xy-plane). The first section 854-1 is significantly longer (at least by a factor of 2, e.g., 2, 2.5, 3, 3.5, 4) along the y-axis in comparison to the second section 854-2. Further, the first section 854-1 includes a substantially planar surface and side walls that extend in a direction of the z-axis from the substantially planar surface (e.g., toward the front of the doorbell 226). The side walls of the first section 854-1 help transfer heat generated by the MLB subassembly 852 toward the lateral sides (e.g., left and right lateral sides relative to the front surface 612 of the front housing component 702) of the housing. During cold ambient temperatures, the side walls of the first section 854-1 help transfer heat from heat-dissipating components on the MLB subassembly 852 to the internal air of the assembly to warm the battery 828 (further details of warming the battery 828 are described with respect to FIGS. 9 and 10).

A gasket 856 (e.g., an O-ring) may be disposed between the rear housing component 704 and the front housing component 702 to form a seal and prevent water ingress along the seam between the housing components 702 and 704. The doorbell 226 may also include a label plate 858 for adding and/or interchanging one or more labels. Electrical connectors 860 (e.g., wiring, dongle) are used to connect the doorbell 226 to line power.

FIG. 9 illustrates a portion of the exploded view 800 of FIG. 8, showing a rear side of the heat sink 854, the MLB subassembly 852, and a battery subassembly 902. The battery subassembly 902 includes the battery 828, which is fully or partially enveloped by the thermal management subassembly 832 and positioned in the battery frame 830. In some implementations, electrical energy from the battery 828 may only be used when a chime event occurs. In additional implementations, the video-capturing doorbell 262 may use the battery 828 to power some or all electrical components of the video-capturing doorbell 262. In still further implementations, the video-capturing doorbell 262 may use the battery 828 in conjunction with the line power, which is connected via the electrical connectors (e.g., the electrical connectors 860), to activate (e.g., power) any combination of the MLB subassembly 852, the battery heater 426, the camera subassembly 842, and so on. In one example, the doorbell 226 runs on battery power over a predefined duration of time (e.g., 8 seconds(s), 10 s, 11 s, 15 s) in which the chime is ringing.

Generally, the battery 828 has an operating temperature range for optimal performance. At high temperatures, batteries can experience degradation due to overperformance of the battery chemistry. At low temperatures (e.g., sub-zero temperatures), conventional batteries perform poorly due to the cold, causing slow chemical reactions in the battery chemistry. Different batteries may have different operating temperature ranges. For example, some batteries have an operating temperature range with a low-temperature boundary of 10° C. (e.g., a range from 10° C. to 80° C.). Some batteries may have an operating temperature range with a low-temperature boundary of 5° C. (e.g., a range from 5° C. to 85° C.). Accordingly, an ambient temperature down to e.g., −20° C. with approximately 1.5 m/s wind, can cause the temperature of the battery 828 to decrease below the low-temperature boundary of the operating temperature range, resulting in a substantially non-operational battery. In such ambient circumstances, however, the battery 828 can be heated using one or more heating mechanisms in proximity to the battery 828.

In one example, the thermal management subassembly 832 may include a heat spreader (e.g., graphite) that fully or partially envelops the battery 828 to distribute heat generated by the heating mechanism(s) or the battery 828. In so doing, the heat spreader maintains a gradient across the battery 828 within a certain level (e.g., less than 5° C.). In some sub-zero ambient temperatures, however, many conventional battery heaters (e.g., a flexible circuit heater) may be insufficient to maintain the battery temperature at or above the low-temperature boundary.

In aspects, the one or more heating mechanisms (e.g., battery heater 426) may include resistors 904 disposed on a side of the MLB subassembly 852 that interfaces with the heat sink 854. The illustrated example shows six (6) resistors 904 on the MLB subassembly 852. However, any suitable number of resistors 904 may be disposed on the MLB subassembly 852 at any suitable location on the MLB subassembly 852. In one example, the resistors 904 are disposed toward one end of the MLB subassembly 852. In the illustrated example, the resistors 904 are disposed at a region that is approximately a quarter of the length of the MLB subassembly 852 along a longitudinal axis 906 of the MLB subassembly 852. The resistors 904 are board-resistor heaters. In aspects, current is provided to the resistors 904 to overdrive the resistors 904 and cause the resistors 904 to dissipate heat. Any suitable amount of current or power can be used to overdrive the resistors 904. In one example, power within a range of 3 Watts (W) to 5 W (including 4 W) is driven into the resistors 904 to cause the resistors 904 to dissipate heat. The power may be provided by the battery 828 during a chime event (e.g., when the button is pressed). During low temperatures (e.g., sub-zero ambient temperatures), the resistors 904 can be overdriven in this way.

When assembled, the resistors 904 thermally connect to the heat sink 854, via a thermal interface material 908 (e.g., thermal gel), to provide heat to indirectly heat the battery 828. For example, the resistors 904 provide heat, which is transferred to the heat sink 854. Then, the heat sink 854 transfers the heat to the internal air of the doorbell 226, which warms the battery 828. Further, the thermal management subassembly 832 including the heat spreader distributes the heat from the internal air across multiple surfaces of the battery 828. Accordingly, using the resistors 904 described herein enables the battery 828 to be heated to within its operating temperature range during cold ambient temperatures in a manner that maintains the gradient across the battery 828 within a desired level.

The MLB subassembly 852 may further include (not illustrated/labeled) a processing unit, which may include a system-on-a-chip (SoC), one or more processors, a computer-readable medium, and at least one thermistor in proximity to the battery subassembly 902. For example, thermistors can be disposed on a face of the MLB subassembly 852 opposite the resistors 904. The thermistors (e.g., a resistor whose resistance is highly correlated with varying temperatures) may be configured to measure temperatures of one or more regions surrounding the battery 828. The thermistors can be operatively coupled to the MLB subassembly 852, including the processing unit as well as a heater battery failsafe circuit. In some implementations, the thermistors may be disposed in the thermal management subassembly 832, such as in the battery 828 or a battery pack.

FIG. 10 illustrates an example thermal management subassembly 832 and an example battery subassembly 902 in greater detail. As illustrated, the thermal management subassembly 832 may include a number of layers, including a graphite layer 1002, a battery heating component 1004 (e.g., an electrical flex heater with Inconel traces), a top PSA 1006, and a bottom PSA 1008. The battery heating component 1004 is disposed between a first portion of the graphite layer 1002 and the top PSA layer 1006. The top PSA layer 1006 is configured to affix the battery heating component 1004, as well as the first portion of the graphite layer 1002, to a top face of the battery 828. The bottom PSA layer 1008 is configured to affix a second portion of the graphite layer 1002 to a bottom face of the battery 828. Upon affixing the thermal management subassembly 832 to the battery 828, such that the thermal management subassembly 832 fully or partially envelops the battery 828, the battery 828, and the thermal management subassembly 832 can be positioned into the battery frame 830, defining the battery subassembly 902.

In such a configuration, when the battery heating component 1004 is activated, the generated heat can pass through the top PSA layer 1006 into the battery 828. The heat generated by the battery heating component 1004 can also pass into the graphite layer 1002, which possesses a high thermal conductivity, and, as a result, may conduct heat through the body of the graphite layer 1002 to the bottom PSA layer 1008. The heat may then be conducted into the bottom face of the battery 828.

As described herein, the battery heater 426 may be any component that is operatively coupled to the MLB subassembly 852 and configured to generate heat so as to increase a temperature of one or more regions proximate, adjacent, or internal to the battery 828. As such, the battery heater 426 may be implemented as, and refer to, any combination of resistors 904, the battery heating component 1004, and/or other heating elements.

In aspects, the processing unit on the MLB subassembly 852 may determine a temperature in one or more regions proximate, adjacent, or internal to the battery 828 to be below a minimum threshold temperature. For example, thermistors may measure an internal temperature of the video-capturing doorbell to be near or at the minimum threshold temperature (e.g., −10° C.) due to cold weather conditions of an ambient environment. Due to the internal temperature being at or near (within a tolerance of e.g., 1° C., 1.5° C., 2° C., 3° C., 4° C., 5° C.) the minimum threshold temperature, the processing unit, including an SoC, may activate the battery heater 426 to warm an internal temperature of the video-capturing doorbell. Upon the battery heater 426 warming the one or more regions proximate, adjacent, or internal to the battery 828 to be at or near (within a tolerance of e.g., 1° C., 1.5° C., 2° C., 3° C., 4° C., 5° C.) a desired temperature, the processing component may deactivate the battery heater 426. For example, thermistors may measure an internal temperature of the video-capturing doorbell to be near or at the desired temperature (e.g., 25° C., 30° C.), and the processing unit, as a result, may deactivate the battery heater 426.

In some circumstances, any number of events can occur that may cause the processing unit to lose control of the battery heater 426. For example, a software malfunction (e.g., a glitch, a crash) may cause the processing unit to lose control of the battery heater 426 or fail to deactivate the battery heater 426 when a desired temperature is reached. In such an event, the battery heater 426 may continue to receive an activation signal and, as a result, warm the internal temperature of the video-capturing doorbell, including the battery 828. If the battery temperature exceeds a safe operating temperature range, then the excess heat may cause a catastrophic malfunction and/or damage the battery 828.

To this end, the battery heater failsafe circuit provides an additional layer of oversight, via a physical mechanism, that overrides the software control of the battery heater 426 by the processing unit. For example, if the non-physical, software-based approach fails to deactivate the battery heater 426, then the battery heater failsafe circuit can physically and/or electrically disconnect (e.g., via a switch) the battery heater 426 from the processing unit such that the battery heater 426 no longer receives the activation signal. In an additional implementation, the battery heater failsafe circuit can physically and/or electrically disconnect the battery heater 426 from the battery 828. Consequently, the battery heater 426 then deactivates and ceases to generate heat.

In more detail, while the battery heater 426 is activated by the processing unit, if the at least one thermistor measures an internal temperature of the video-capturing doorbell (e.g., a temperature of the battery 828) to be near or at an upper threshold temperature (e.g., 40° C., 45° C.), then the battery heater failsafe circuit can disconnect the battery heater 426 from the processing unit using a hardware override switch. The battery heater failsafe circuit can also inform the processing unit (e.g., an SoC), via a general-purpose input/output (GIPO) interrupt, that the battery heater failsafe circuit triggered an override. When the processing unit (e.g., the software, the hardware component) recovers, the interrupt can be logged and the processing unit can reassume control of the battery heater 426 (e.g., when the battery heater failsafe circuit determines a lower threshold temperature has been reached). The interrupt can be stored in memory of the video-capturing doorbell, uploaded to the server system 206, and/or logged in the software malfunction events 3630 of the status data 362-o. A client device 228 can then view alerts or the logged events relating to the software malfunction.

### Example Methods

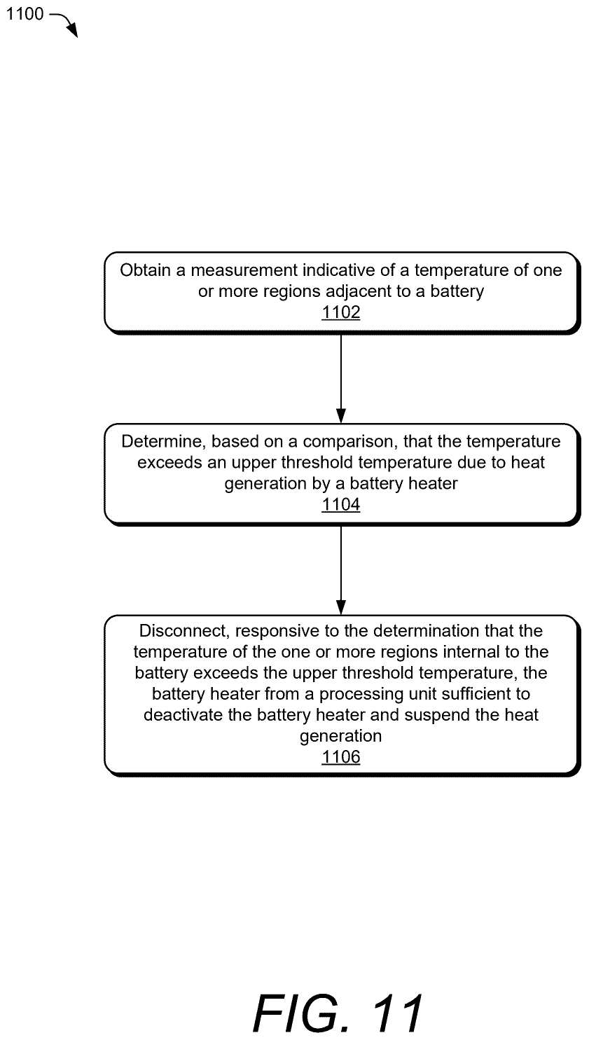

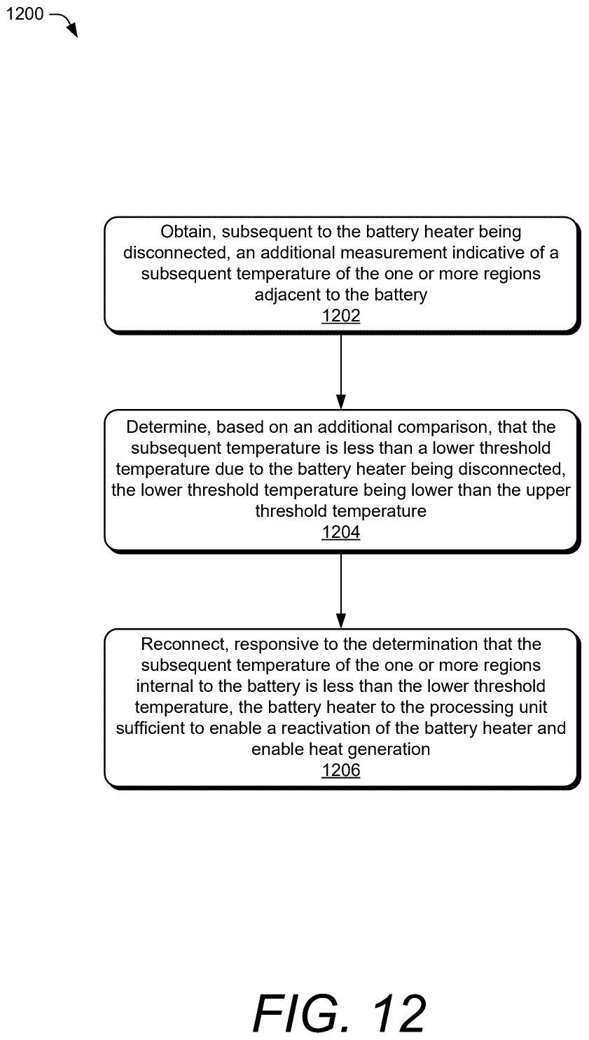

FIGS. 11 and 12 illustrate example methods 1100 and 1200 of the battery heater failsafe circuit in accordance with techniques described herein. The methods 1100 and 1200 are shown as sets of blocks that specify operations (e.g., steps) performed but are not necessarily limited to the order or combinations shown for performing the operations by the respective blocks. For example, any number of the described method blocks can be skipped or combined in any order to implement a method or an alternate method. Further, the method blocks can be duplicated to repeat a step. In portions of the following discussion, reference may be made to entities or environments detailed in FIGS. 1A-10 for example only. The techniques are not limited to performance by one entity or multiple entities operating on one device. In aspects, example method 1100 of the battery failsafe circuit may occur at a chronologically earlier interval than example method 1200. For instance, example method 1200 is configured to occur after one or more operations of example method 1100 are performed.

Generally, any of the components, modules, methods, and operations described herein can be implemented using hardware (e.g., fixed logic circuitry), manual processing, software, firmware, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 11 illustrates an example method 1100 of the battery heater failsafe circuit in accordance with techniques described herein. At operation 1102, the battery heater failsafe circuit obtains a measurement indicative of a temperature of one or more regions proximate, adjacent, or internal to a battery (e.g., battery 828). For example, the battery heater failsafe circuit can monitor (e.g., constantly, periodically) a temperature of a battery using, for example, an integrated thermistor (e.g., a positive temperature coefficient (PTC) thermistor) in a battery pack. As a temperature rises, a resistance associated with the thermistor may correlatively increase. In some implementations, more than one thermistor may be utilized to measure the temperature of the battery and/or the temperature of a region or regions surrounding the battery.

At operation 1104, the battery heater failsafe circuit determines, based on a comparison, that the temperature exceeds an upper threshold temperature due to heat generation by a battery heater. For example, the battery heater failsafe circuit may use a comparator (e.g., an operational amplifier (Op-Amp) comparator circuit) to compare a measurement indicative of the temperature to a first predefined value indicative of the upper threshold temperature. In an implementation, the measurement indicative of the temperature may be a voltage. The voltage may be associated with or influenced by an electrical resistance (e.g., in Ohms) of the thermistor, which is variable depending on temperature. The comparator may compare the voltage measurement to a predefined (e.g., circuit-defined) voltage based on one or more resistances (e.g., implemented using one or more resistors) indicative of the upper threshold temperature. Based on the comparison, the battery heater failsafe circuit can determine that a temperature of one or more regions proximate, adjacent, or internal to the battery exceeds the threshold temperature because of an active heat generation by the battery heater.

In implementations, the battery heater failsafe circuit may determine that the threshold temperature exceeds the upper threshold temperature as a direct result of an active battery heater using one or more switches. In one example, the battery heater failsafe circuit includes a metal-oxide-semiconductor field-effect transistor (MOSFET) having source, gate, and drain terminals. At the source terminal, a ground voltage (e.g., a reference voltage) may be supplied to the MOSFET. At the drain terminal, a battery heater may be electrically coupled to the MOSFET. In operation, when the gate terminal receives a sufficiently high voltage (e.g., 4.5 volts), current may flow through a drain-source channel in the MOSFET. At the gate terminal, a node may connect two or more branches each capable of supplying (or transmitting) a voltage. In combination, a resultant voltage from the two or more branches may enable current flow through the drain-source channel in the MOSFET. A first branch may supply a first voltage (e.g., an activation signal) from a processing unit that, in combination with a second voltage from a second branch, enables current flow. The second voltage from the second branch may be supplied from one or more circuit elements (e.g., a comparator, resistors, switches) in the battery heater failsafe circuit. Further, the second voltage may be configured to remain at a predefined voltage until the battery heater failsafe circuit receives a measurement indicative of a temperature exceeding the threshold temperature. In such an event, the battery heater failsafe circuit (e.g., a comparator) may transmit a low voltage (e.g., a voltage low enough that in combination with the first voltage may not exceed a gate threshold voltage) causing current to cease flowing through the drain-source channel in the MOSFET (e.g., an open switch). When the current ceases to flow through the drain-source channel, the battery heater may deactivate. In this way, the battery heater failsafe circuit determines that a temperature exceeds the upper threshold temperature directly as a result of heat generation by a battery heater. Were it not for the battery heater failsafe circuit opening the switch to disable current flow and deactivate the battery, the switch (e.g., the N-channel MOSFET) would otherwise be closed and enable current flow that results in heat generation by the battery heater. Thus, the battery heater failsafe circuit, including the comparator and the switch (e.g., MOSFET), receives measurements, compares the measurements, and, based on the comparison, determines a condition. Although, this example describes the battery heater failsafe circuit using a N-channel enhancement-type MOSFET, the battery heater failsafe circuit may alternatively, or additionally, use a N-channel depletion-type MOSFET, a P-channel enhancement-type MOSFET, a bipolar junction transistor (BJT), and so on.

At operation 1106, the battery heater failsafe circuit disconnects, responsive to the determination that the temperature exceeds the upper threshold temperature, the battery heater from a processing unit sufficient to deactivate the battery heater and suspend the heat generation by the battery heater. In implementations, the battery heater failsafe circuit physically and/or electrically disconnects the battery heater from the processing unit, using, for example, an electrical switch (e.g., a MOSFET). In this way, if a software malfunction causes the processing unit to continue to enable heat generation by the battery heater despite having reached a desired temperature, the battery heater failsafe circuit can prevent heat-related damage to the battery and the video-capturing doorbell by disconnecting the battery heater from the processing unit. In additional implementations, the battery heater failsafe circuit can disconnect the battery heater from the battery. In any of these implementations, due to the disconnection, the battery heater may no longer generate heat. This can enable heat to eventually dissipate away from the battery into an ambient environment, reducing the internal temperature of the video-capturing doorbell to a safer operating temperature range for the battery.

FIG. 12 illustrates an example method 1200 of the battery heater failsafe circuit in accordance with techniques described herein. Example method 1200 may occur after one or more operations of example method 1100 are performed. At operation 1202, the battery heater failsafe circuit obtains, after the battery heater is disconnected, an additional measurement indicative of a subsequent temperature of the one or more regions proximate, adjacent, or internal to the battery. The additional measurement of the subsequent temperature may be collected and received by the battery heater failsafe circuit at any time after the battery heater is disconnected from the processing unit and/or the battery.

At operation 1204, the battery heater failsafe circuit determines, based on an additional comparison, that the subsequent temperature is less than a lower threshold temperature due to the battery heater being disconnected. In aspects, the lower threshold temperature is lower than the upper threshold temperature. For example, the battery heater failsafe circuit may use a comparator (e.g., an operational amplifier (Op-Amp) comparator circuit) to compare an additional measurement indicative of the subsequent temperature to a second predefined value indicative of the lower threshold temperature. In an implementation, the additional measurement indicative of the subsequent temperature may be a voltage. The voltage may be associated with or influenced by an electrical resistance (e.g., in Ohms) of the thermistor, which is variable depending on a temperature. The comparator may compare the voltage measurement to a predefined (e.g., circuit-defined) voltage based on one or more resistances (e.g., implemented using one or more resistors) indicative of the lower threshold temperature. Based on the comparison, the battery heater failsafe circuit can determine that the subsequent temperature of one or more regions proximate, adjacent, or internal to the battery is less than a threshold temperature because of the battery heater being disconnected from the processing unit and/or battery.

In implementations, the battery heater failsafe circuit may determine, using one or more switches, that the subsequent temperature is less than the lower threshold temperature as a direct result of a deactivated battery heater. In one example, the battery heater failsafe circuit includes a N-channel MOSFET that is open due to a comparator transmitting a low voltage because a thermistor previously measured a temperature exceeding an upper threshold temperature. At a later interval, the thermistor may measure a subsequent temperature equal to or lower than a lower threshold temperature, causing the comparator to transmit a high voltage. In this way, the battery heater failsafe circuit determines that the subsequent temperature is less than the lower threshold temperature as a direct result of the deactivated battery heater; for, the comparator is configured to transmit the low voltage and deactivate the battery heater when a measured temperature exceeds the upper threshold temperature.

At operation 1206, the battery heater failsafe circuit reconnects, responsive to the determination that the subsequent temperature is less than the lower threshold temperature, the battery heater to the processing unit and, optionally, the battery sufficient to enable a reactivation of the battery heater and enable heat generation. For example, the battery heater failsafe circuit may close a switch to physically and/or electrically reconnect the battery heater to the processing unit. In aspects, the reconnection may not cause the battery heater to immediately reactivate and begin generating heat. Instead, the reconnection is sufficient to enable the battery heater to be reactivated at a time subsequent to the reconnection and generate heat based on the reactivation. Due to the reconnection, by the time the battery heater failsafe circuit determines that the subsequent temperature is less than a lower threshold temperature, the processing unit and/or software operating on the processing unit may have recovered and can again regain control of the battery heater.

Further to the above descriptions, the battery heater failsafe circuit can also implement hysteresis to prevent oscillations of software (e.g., processing unit software) and hardware (e.g., battery heater failsafe circuit) control. For instance, if the battery heater failsafe circuit disconnects and reconnects the battery heater from the processing unit at one threshold temperature, then the battery heater may oscillate between a disconnected state and a reconnected state. Instead, two threshold temperatures are described: an upper threshold temperature (e.g., 45° C.) and a lower threshold temperature (e.g., 30° C.). In this way, the battery heater failsafe circuit can implement a hysteresis window.

### Example Implementations

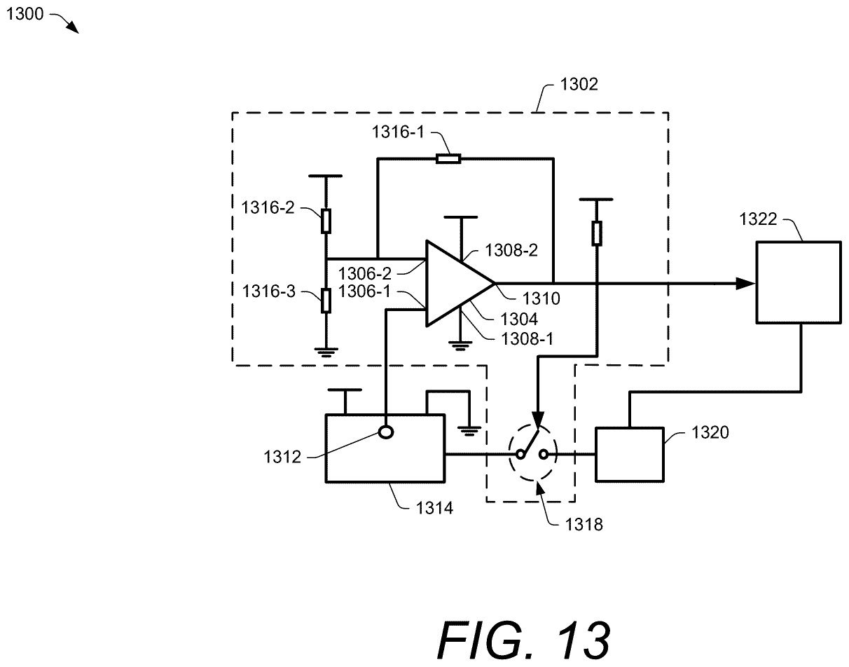

FIG. 13 illustrates an example implementation 1300 of the battery heater failsafe circuit 1302 in accordance with systems and techniques described herein. As illustrated, the battery heater failsafe circuit 1302 includes an Op-Amp comparator 1304 (e.g., an inverting comparator circuit) with two inputs 1306 (e.g., first input 1306-1, second input 1306-2), two supply rails (e.g., a positive supply rail 1308-1, a negative supply rail 1308-2), and an output 1310. In aspects, based on a configuration of the battery heater failsafe circuit 1302, the Op-Amp comparator 1304 may be configured to implement hysteresis (e.g., a hysteresis band). In alternate implementations, in lieu of the Op-Amp comparator 1304, the battery heater failsafe circuit 1302 may include any other type of hardware or firmware component(s) configured to compare a difference between two or more inputs and generate an output.

In aspects, the Op-Amp comparator 1304 receives, at the first input 1306-1 (e.g., an inverting input, a main input) and from an output of a thermistor 1312, a voltage measurement indicative of a temperature from one or more regions proximate, adjacent, or internal to a battery 1314 (e.g., the battery 424). The Op-Amp comparator 1304 further receives, at the second input 1306-2 (e.g., a non-inverting input), a reference voltage. The reference voltage, which is based on a resistance of one or more resistors 1316 (e.g., resistor 1316-1, resistor 1316-2, resistor 1316-3), is then compared to the voltage measurement at the first input 1306-1. In such a configuration, when the voltage of the first input 1306-1 is less than the voltage of the second input 1306-2, the output 1310 of the Op-Amp comparator 1304 saturates towards the positive supply rail 1308-1. If, however, the first input 1306-1 is greater than the second input 1306-2, then the output 1310 of the Op-Amp comparator 1304 saturates towards the negative supply rail 1308-2. The amount of hysteresis is determined by a feedback fraction of a voltage fed back from the output 1310 to the non-inverting input. In more detail, the hysteresis of the battery heater failsafe circuit 1302 may be based on a combination of resistors 1316, including one feedback resistor (e.g., resistor 1316-1) and two input resistors (e.g., resistor 1316-2 and resistor 1316-3), which may define a lower and an upper threshold temperature. The lower threshold temperature and the upper threshold temperature may be set, based on the resistances of the resistors 1316, such that a battery chemistry may not be negatively affected by varying internal temperatures.

The battery heater failsafe circuit 1302 may further include any of a variety of additional circuit components, including one or more switches (e.g., N-Channel MOSFETs), resistors, amplifiers, and so forth. For example, the battery heater failsafe circuit 1302 may include N-channel MOSFETs and resistors to alter a voltage of the output 1310. In one implementation, illustrated in FIG. 13, the battery heater failsafe circuit 1302 includes a switch 1318, which is configured to disconnect a battery heater 1320 from the battery 1314 such that the battery heater 1320 no longer receives power to enable heat generation. In an additional implementation, not illustrated, the switch 1318 may disconnect the battery heater 1320 from a processing unit 1322 (e.g., an SoC) such that the battery heater 1320 no longer receives an activation signal to enable heat generation. In this way, based on a comparison by the Op-Amp comparator 1304, the battery heater failsafe circuit 1302 can provide a hardware-based approach to protect a battery of a video-capturing doorbell from overheating if software malfunctions.

In an additional implementation, a temperature of one or more regions proximate, adjacent, or internal to a battery may be inferred based on an amount of current, voltage, or power supplied to a battery heater, or a duration of time (e.g., a length of time the battery heater receives an activating signal). For example, a power monitoring circuit may be utilized to monitor an amount of power supplied to the battery heater. Based on one or more of these conditions, the comparator may be configured to receive, at the first input 1306-1, a voltage that causes the battery heater 1320 to be physically and/or electrically disconnected from the battery 1314 and/or the processing unit 1322.

Although the battery heater has been described as specifically heating a battery, it should be understood that the battery heater may be extended to warming altogether different and/or additional subsystems within the electronic device. Further, although the systems and techniques of the battery heater failsafe circuit are described herein in relation to a video-capturing doorbell, the systems and techniques of the battery heater failsafe circuit as described herein can also or alternatively be implemented in any other of a multitude of electronic devices such as automobiles, airplanes, machinery, wireless communication devices, handheld electronic devices, and so on.

### ADDITIONAL EXAMPLES

In the following section, additional examples are provided.

Example 1: A video-capturing doorbell comprising: a battery configured to supply electrical energy to one or more electrical components within the video-capturing doorbell; a heat sensor configured to measure a temperature of one or more regions proximate, adjacent, or internal to the battery; a battery heater configured to generate heat to warm the battery and/or an internal temperature of the video-capturing doorbell; a processing unit configured to activate and deactivate the battery heater; and a battery heater failsafe circuit configured to: determine, based on a comparison, that the temperature of the one or more regions internal to the battery exceeds an upper threshold temperature due to the heat generation by the battery heater; and disconnect, responsive to the determination that the temperature exceeds the upper threshold temperature, the battery heater from the processing unit sufficient to deactivate the battery heater and suspend the heat generation.

Example 2: The video-capturing doorbell of example 1, wherein the battery heater failsafe circuit is further configured to: determine, based on a subsequent temperature of the one or more regions internal to the battery measured by the heat sensor and an additional comparison and a later measurement from the heat sensor, that a subsequent temperature is less than a lower threshold temperature due to the battery heater being disconnected, the lower threshold temperature being lower than the upper threshold temperature; and reconnect, responsive to the determination that the subsequent temperature is less than the lower threshold temperature, the battery heater to the processing unit sufficient to enable reactivation of the battery heater and enable heat generation.

Example 3: The video-capturing doorbell of example 2, wherein the heat generation by the battery heater is suspended for at least a duration extending from the disconnection to the reconnection of the battery heater.

Example 4: The video-capturing doorbell of example 2 or example 3, wherein the battery heater failsafe circuit comprises a comparator circuit configured to: perform at least one of the comparison or the additional comparison; and output a voltage effective to enable at least one of the disconnection or reconnection, respectively.

Example 5: The video-capturing doorbell of example 4, wherein the comparator circuit is an inverting operational-amplifier comparator with a hysteresis circuit configured having a circuit-defined reference voltage, based on a plurality of resistors, at a non-inverting input.

Example 6: The video-capturing doorbell of example 5, wherein: the heat sensor is further configured to: transmit a measurement as a first voltage indicative of the temperature to the processing unit and the battery heater failsafe circuit; and transmit an additional measurement as a second voltage indicative of the subsequent temperature to the processing unit and the battery heater failsafe circuit; and the battery heater failsafe is further configured to: compare, responsive to receipt of the first voltage indicative of the temperature, the first voltage to a first reference voltage corresponding to the upper threshold temperature; and compare, responsive to receipt of the second voltage indicative of the subsequent temperature, the second voltage to a second reference voltage corresponding to the lower threshold temperature.

Example 7: The video-capturing doorbell of example 6, wherein the plurality of resistors are configured to implement a hysteresis band via the first reference voltage and the second reference voltage.

Example 8: The video-capturing doorbell of any previous example, wherein the battery heater failsafe circuit is further configured to: transmit, responsive to the disconnection, a notification signal to the processing unit, the notification signal indicative of the disconnection.

Example 9: The video-capturing doorbell of example 8, wherein the processing unit is a system-on-a-chip comprising: a non-transitory computer-readable medium configured to store data; and a microcontroller configured to: activate and deactivate the battery heater; and receive and transmit data to the non-transitory computer-readable medium.

Example 10: The video-capturing doorbell of example 9, wherein the notification signal is transmitted via a general-purpose input/output interrupt to the microcontroller and stored in the non-transitory computer-readable medium.

Example 11: The video-capturing doorbell of any previous example, wherein the battery heater comprises at least one of a plurality of resistors or an electrical heat flex with Inconel traces.

Example 12: The video-capturing doorbell of any previous claim, wherein the heat sensor is physically integrated in the battery, and wherein the battery heater, the heat sensor, and the battery are packaged together in a thermal management subassembly.

Example 13: The video-capturing doorbell of any previous example, wherein the processing unit is wirelessly connected to a server system having a status database, the wireless connection is sufficient to enable data exchange between the processing unit and the server system, the data exchange relating to a thermal condition of the video-capturing doorbell.

Example 14: A method of a video-capturing doorbell, the method comprising: measuring a temperature of one or more regions proximate, adjacent, or internal to a battery; determining, based on a comparison, that the temperature exceeds an upper threshold temperature due to heat generation by a battery heater; and disconnecting, responsive to determining that the temperature exceeds an upper threshold temperature, the battery heater from a processing unit sufficient to deactivate the battery heater and suspend the heat generation.

Example 15: The method of example 14, further comprising: measuring, after disconnecting the battery heater, a subsequent temperature of the one or more regions proximate, adjacent, or internal to the battery; determining, based on an additional comparison, that the subsequent temperature is less than a lower threshold temperature due to the battery heater being disconnected, the lower threshold temperature being lower than the upper threshold temperature; and reconnecting, responsive to determining that the subsequent temperature is less than the lower threshold temperature, the battery heater to the processing unit sufficient to enable a reactivation of the battery heater and enable heat generation.

### Conclusion

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying Drawings and terms discussed herein may be indicative of one or more items or terms, and thus reference may be made interchangeably to single or plural forms of the items and terms in this written description.

Although implementations for a battery heater failsafe circuit have been described in language specific to certain features and/or methods, the subject of the appended Claims is not necessarily limited to the specific features or methods described. Rather, the specific features and methods are disclosed as example implementations for a battery heater failsafe circuit.

1. A video-capturing doorbell comprising:
a battery configured to supply electrical energy to one or more electrical components within the video-capturing doorbell;
a heat sensor configured to measure a temperature of one or more regions internal to the battery;
a battery heater configured to generate heat to warm the battery of the video-capturing doorbell;
a processing unit configured to activate and deactivate the battery heater; and
a battery heater failsafe circuit configured to:
determine, based on a comparison, that the temperature of the one or more regions internal to the battery exceeds an upper threshold temperature due to the heat generation by the battery heater; and
disconnect, responsive to the determination that the temperature exceeds the upper threshold temperature, the battery heater from the processing unit sufficient to deactivate the battery heater and suspend the heat generation.

2. The video-capturing doorbell of claim 1, wherein the battery heater failsafe circuit is further configured to:
determine, based on a subsequent temperature of the one or more regions internal to the battery measured by the heat sensor and an additional comparison, that the subsequent temperature is less than a lower threshold temperature due to the battery heater being disconnected, the lower threshold temperature being lower than the upper threshold temperature; and
reconnect, responsive to the determination that the subsequent temperature is less than the lower threshold temperature, the battery heater to the processing unit sufficient to enable reactivation of the battery heater and enable heat generation.

3. The video-capturing doorbell of claim 2, wherein the heat generation by the battery heater is suspended for at least a duration extending from the disconnection to the reconnection of the battery heater.

4. The video-capturing doorbell of claim 2, wherein the battery heater failsafe circuit comprises a comparator circuit configured to:
perform at least one of the comparison or the additional comparison; and
output a voltage effective to enable at least one of the disconnection or reconnection, respectively.

5. The video-capturing doorbell of claim 4, wherein the comparator circuit is an inverting operational-amplifier comparator with a hysteresis circuit configured having a circuit-defined reference voltage, based on a plurality of resistors, at a non-inverting input.

6. The video-capturing doorbell of claim 5, wherein:
the heat sensor is further configured to:
transmit a measurement as a first voltage indicative of the temperature to the processing unit and the battery heater failsafe circuit; and
transmit an additional measurement as a second voltage indicative of the subsequent temperature to the processing unit and the battery heater failsafe circuit; and
the battery heater failsafe is further configured to:
compare, responsive to receipt of the first voltage indicative of the temperature, the first voltage to a first reference voltage corresponding to the upper threshold temperature; and
compare, responsive to receipt of the second voltage indicative of the subsequent temperature, the second voltage to a second reference voltage corresponding to the lower threshold temperature.

7. The video-capturing doorbell of claim 6, wherein the plurality of resistors are configured to implement a hysteresis band via the first reference voltage and the second reference voltage.

8. The video-capturing doorbell of claim 1, wherein the battery heater failsafe circuit is further configured to:
transmit, responsive to the disconnection, a notification signal to the processing unit, the notification signal indicative of the disconnection.

9. The video-capturing doorbell of claim 8, wherein the processing unit is a system-on-a-chip comprising:
a non-transitory computer-readable medium configured to store data; and
a microcontroller configured to:
activate and deactivate the battery heater; and
receive and transmit data to the non-transitory computer-readable medium.

10. The video-capturing doorbell of claim 9, wherein the notification signal is transmitted via a general-purpose input/output interrupt to the microcontroller and stored in the non-transitory computer-readable medium.

11. The video-capturing doorbell of claim 1, wherein the battery heater comprises at least one of a plurality of resistors or an electrical heat flex with Inconel traces.

12. The video-capturing doorbell of claim 1,
wherein the heat sensor is physically integrated in the battery, and
wherein the battery heater, the heat sensor, and the battery are packaged together in a thermal management subassembly.

13. The video-capturing doorbell of claim 1, wherein the processing unit is wirelessly connected to a server system having a status database, the wireless connection is sufficient to enable data exchange between the processing unit and the server system, the data exchange relating to a thermal condition of the video-capturing doorbell.

14. A method comprising:
obtaining a measurement indicative of a temperature of one or more regions internal to a battery, the battery in thermal communication with a battery heater;
determining, during operation of the battery heater and based on a comparison, that the temperature exceeds an upper threshold temperature; and
disconnecting, responsive to determining that the temperature exceeds the upper threshold temperature, the battery heater from a processing unit, the disconnecting sufficient to deactivate the battery heater.

15. The method of claim 14, further comprising:
obtaining, after disconnecting the battery heater, an additional measurement indicative of a subsequent temperature of the one or more regions internal to the battery;
determining, during inactivity of the battery heater and based on an additional comparison, that the subsequent temperature is less than a lower threshold temperature, the lower threshold temperature being lower than the upper threshold temperature; and
reconnecting, responsive to determining that the subsequent temperature is less than the lower threshold temperature, the battery heater to the processing unit, the reconnecting sufficient to enable a reactivation of the battery heater.

16. A computer-readable storage medium comprising instructions that, when executed by one or more processors, cause the one or more processors to perform operations including:
obtaining a measurement indicative of a temperature of one or more regions internal to a battery, the battery in thermal communication with a battery heater;
determining, during operation of the battery heater and based on a comparison, that the temperature exceeds an upper threshold temperature; and
disconnecting, responsive to determining that the temperature exceeds the upper threshold temperature, the battery heater from a processing unit, the disconnecting sufficient to deactivate the battery heater.

17. The computer-readable storage medium of claim 16, further comprising:
obtaining, after disconnecting the battery heater, an additional measurement indicative of a subsequent temperature of the one or more regions internal to the battery;
determining, during inactivity of the battery heater and based on an additional comparison, that the subsequent temperature is less than a lower threshold temperature, the lower threshold temperature being lower than the upper threshold temperature; and
reconnecting, responsive to determining that the subsequent temperature is less than the lower threshold temperature, the battery heater to the processing unit, the reconnecting sufficient to enable a reactivation of the battery heater.

18. The computer-readable storage medium of claim 17, wherein:
the heat generation by the battery heater is suspended for at least a duration extending from the disconnection to the reconnection of the battery heater.

19. The computer-readable storage medium of claim 17, further comprising:
performing at least one of the comparison or the additional comparison; and
outputting a voltage effective to enable at least one of the disconnection or reconnection, respectively.

20. The computer-readable storage medium of claim 16, further comprising:
transmitting, responsive to the disconnection, a notification signal to the processing unit, the notification signal indicative of the disconnection, the notification signal being transmitted via a general purpose input/output interrupt to a microcontroller and stored in the computer-readable storage medium.
